(19) United States
(12) Patent Application Publication
(10) Pub. No.: US 2025/0122402 A1
(43) Pub. Date: Apr. 17, 2025

(54) LONG SHELF-LIFE STABLE MASS POLYMERIZABLE POLYCYCLOOLEFIN COMPOSITIONS CONTAINING PYRIDINE LIGATED PALLADIUM COMPOUNDS

(71) Applicant: PROMERUS, LLC, AKRON, OH (US)

(72) Inventors: PAUL D. BYRNE, AKRON, OH (US); CHERYL BURNS, AKRON, OH (US); CAROLYN SCHERGER, AKRON, OH (US)

(73) Assignee: PROMERUS, LLC, AKRON, OH (US)

(21) Appl. No.: 18/911,843

(22) Filed: Oct. 10, 2024

Related U.S. Application Data
(60) Provisional application No. 63/543,452, filed on Oct. 10, 2023.

(51) Int. Cl. C09D 145/00; C08F 32/08; C09D 4/00

(52) U.S. Cl. CPC C09D 145/00; C08F 32/08; C09D 4/00

(57) ABSTRACT

Embodiments in accordance with the present invention encompass compositions comprising a heteroaryl compound ligated palladium compound, a photoacid generator, a photosensitizer and one or more olefinic monomers which undergo vinyl addition polymerization only when said composition is exposed to a suitable actinic radiation to form a substantially transparent film. The composition of this invention exhibit unusual shelf-life stability and are photolytically active even in the presence of air. The monomers employed therein have a range of optical and mechanical properties, and thus these compositions can be tailored to form films, including thin films, having various opto-electronic properties even under atmospheric conditions without the need of inert atmosphere. Accordingly, compositions of this invention are useful in various applications, including as coatings, encapsulants, fillers, leveling agents, among others.

### CROSS REFERENCE TO RELATED APPLICATIONS

This application claims the benefit of U.S. Provisional Application No. 63/543,452, filed Oct. 10, 2023, which is incorporated herein by reference in its entirety.

### BACKGROUND OF THE INVENTION

### Field of the Invention

Embodiments in accordance with the present invention relate generally to long shelf life-stable mass polymerizable polycycloolefin monomer compositions containing a variety of heteroaromatic base ligated palladium catalysts having utility in such applications as optical sensors, light emitting diodes (LEDs), organic light emitting diode (OLED), among others. More specifically, this invention relates to single component compositions encompassing a variety of functionalized norbornene monomers, which undergo mass vinyl addition polymerization in the presence of a photoacid generator when subjected to suitable actinic radiation and forms optical layers having utility in a variety of opto-electronic applications including as encapsulants, coatings, fillers, among other uses.

### Description of the Art

Organic light emitting diodes (OLEDs) are gaining importance in a variety of applications, including flat panel televisions and other flexible displays, among other applications. However, conventional OLEDs, particularly, bottom emitting OLEDs suffer from a drawback in that only about half of the generated photons are emitted into the glass substrate out of which 25% are extracted into air. The other half of the photons are wave-guided and dissipated in the OLED stack. This loss of photons is primarily attributed to the refractive index (n) mismatch between the organic layers (n=1.7-1.9) and the glass substrate (n=1.5). By matching the refractive index of the substrate (n=1.8) and organic layers and augmenting the distance of the emission zone to the cathode to suppress plasmonic losses light extraction into the substrate can be increased to 80-90%. See, for example, G. Gaertner et al., Proc. Of SPIE, Vol. 6999, 69992T pp 1-12 (2008).

In addition, OLEDs also pose other challenges; in that OLEDs being organic materials, they are generally sensitive to moisture, oxygen, temperature, and other harsh conditions. Thus, it is imperative that OLEDs are protected from such harsh atmospheric conditions. See for example, U. S. Patent Application Publication No. US2012/0009393 A1.

In order to address some of the issues faced by the art, U.S. Pat. No. 8,263,235 discloses use of a light emitting layer formed from at least one organic light emitting material and an aliphatic compound not having an aromatic ring, and a refractive index of the light emitting from 1.4 to 1.6. The aliphatic compounds described therein are generally a variety of polyalkyl ethers, and the like, which are known to be unstable at high temperatures, see for example, Rodriguez et al., I & EC Product Research and Development, Vol. 1, No. 3, 206-210 (1962).

U.S. Pat. Nos. 9,944,818 and 10,266,720, disclose a two-component mass polymerizable composition which is capable of tailoring to the desirable refractive index and is suitable as a filler and a protective coating material, thus potentially useful in the fabrication of a variety of OLED devices.

U.S. Pat. No. 10,626,198 B2, discloses a single component mass vinyl addition polymerizable composition which is thermally activated and capable of tailoring to the desirable refractive index and is suitable as a filler and a protective coating material, thus potentially useful in the fabrication of a variety of OLED devices.

However, there is still a need for organic filler materials that are stable at room temperature (for example in the temperature range of from about 20° C. to 40° C.) and undergo mass polymerization only when subjected to suitable actinic conditions (or appropriate thermolytic conditions), more suitably at the fabrication conditions of a device. There is also desirability that such compositions are not only stable under atmospheric conditions (i.e., in the presence of air) but also active when subjected to suitable actinic conditions. Also, there is a need that such compositions form solid objects under such conditions and exhibit high transparency and good thermal properties, among other desirable properties. In addition, it is desirable that such organic filler materials readily form a permanent protective coatings and are available as a single component composition for dispensing with such OLED layers simply by exposing to suitable actinic radiation at ambient temperature (generally at atmospheric temperatures ranging from about 20° C. to 40° C.).

It has been observed in some of these compositions the palladium catalyst which is generally employed to mass polymerize the cyclic olefinic monomer is too reactive rendering such compositions to polymerize prematurely and form solid objects thus rendering such compositions unsuitable for a variety of applications.

Thus, it is an object of this invention to provide organic materials that overcome the gaps faced by the art. More specifically, it is an object of this invention to provide a single component composition that will mass polymerize only when exposed to suitable actinic radiation under the conditions of the fabrications of an OLED device. It is further an object of this invention to provide stable single component mass polymerizable composition with no change in viscosity at or below normal storage conditions but which undergoes mass polymerization only when exposed to suitable actinic radiation, and where the composition is stable at room temperatures for several days.

It is further an object of this invention to provide single component composition that can be used in a variety of other applications including for example 3D printing, ink-jettable coatings, sealants, and the like.

Other objects and further scope of the applicability of the present invention will become apparent from the detailed description that follows.

### SUMMARY OF THE INVENTION

Surprisingly, it has now been found that by employing a heteroaryl nitrogen containing compound ligated to a palladium compound in a single component composition, it is now possible to extend that shelf life stability of the composition yet it is readily activated when subjected to suitable actinic radiation even in the presence of air thereby it is now possible to fabricate a variety of devices including for example an OLED device having a transparent optical layer which features hitherto unachievable properties, i.e., refractive index in the range of 1.4 to 1.6 or higher, high colorless optical transparency, low dielectric constant (Dk) and low-loss, also referred to as dielectric dissipation factor, (Df), and desirable film thickness of the filler layer typically in the range of 1 to 20 m but can be tailored to lower or higher film thickness depending upon the intended application, compatible with the OLED stack, particularly the cathode layer (a very thin layer on the top of the OLED stack), compatible with polymerization of the formulation on the OLED stack, including fast polymerization time and can be photolytically treated at ambient fabrication conditions, adhesion to both OLED stack and glass cover, and the like. It is also important to note that the compositions of this invention are expected to exhibit good uniform leveling across the OLED layer which typically requires a low viscosity. Further, compositions of this invention are also expected to exhibit low shrinkage due to their rigid polycycloolefinic structure. In addition, as the components of this invention undergo fast mass polymerization upon application, they do not leave behind any fugitive small molecules which can damage the OLED stack. Generally, no other small molecule additives need to be employed thus offering additional advantages. Most importantly, the compositions of this invention are stable (i. e., no change in viscosity) at ambient atmospheric conditions including up to 40° C. for several days to weeks and undergo mass polymerization only when exposed to suitable actinic radiation. The compositions undergo mass vinyl addition polymerization very quickly when subjected to such actinic radiation and generally the compositions become solid objects in few minutes, i.e., within 1-10 minutes and more generally in less than one hour. An additional advantage of the composition of this invention is that thin films formed therefrom can be readily cured even in the presence of air whereas prior art compositions especially containing phosphine ligated palladium compounds are inactive in the presence of air.

Advantageously, the compositions of this invention are also compatible with a “one drop fill” (commonly known as “ODF”). In a typical ODF process, which is commonly used to fabricate a top emission OLED device, a special optical fluid is applied to enhance the transmission of light from the device to the top cover glass, and the fluid is dispensed by an ODF method. Although the method is known as ODF which can be misleading because several drops or lines of material are generally dispensed inside the seal lines. After applying the fluid, the fluid spreads out as the top glass is laminated, analogous to die-attach epoxy. This process is generally carried out under vacuum to prevent air entrapment. The present invention allows for a material of low viscosity which readily and uniformly coats the substrate with rapid flow in a short period of time. Even more advantageously, the present invention overcomes the deficiencies faced by the prior art in that a single component composition is much more convenient than employing a two-component system especially in an ODF method.

Accordingly, there is provided a single component composition encompassing a) a palladium compound of formula (I) as described herein; b) a photoacid generator of formula (II) or (III) as described herein; c) one or more olefinic monomers of formula (IV); and d) a photosensitizer.

In another aspect of this invention there is also provided a kit encompassing the composition of this invention for forming a three-dimensional object, such as for example, a transparent film.

### DETAILED DESCRIPTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, the symbol “ [symbol] ” denotes a position at which the bonding takes place with another repeat unit or another atom or molecule or group or moiety as appropriate with the structure of the group as shown.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” includes methyl and ethyl groups, and straight-chained or branched propyl, butyl, pentyl and hexyl groups, and the like including up to specified carbon atoms. Particular alkyl groups are methyl, ethyl, n-propyl, isopropyl and tert-butyl. Derived expressions such as “alkoxy”, “thioalkyl” “alkoxy(C₁-C₄)alkyl”, “hydroxyalkyl”, “alkylcarbonyl”, “alkoxycarbonyl(C₁-C₄)alkyl”, “alkoxycarbonyl”, “diphenylalkyl”, “phenylalkyl”, “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy”, “cycloalkylalkyl”, “cycloalkylaryl”, “cycloalkylcarbonyl” are to be construed accordingly.

As used herein, the expression “perfluoroalkyl” means that all of the hydrogen atoms in said alkyl group with specified number of carbon atoms are replaced with fluorine atoms. Illustrative examples include trifluoromethyl and pentafluoroethyl, and straight-chained or branched heptafluoropropyl, nonafluorobutyl, undecafluoropentyl and tridecafluorohexyl groups. Derived expression, “perfluoroalkoxy”, is to be construed accordingly. It should further be noted that certain of the alkyl groups as described herein may partially be fluorinated, that is, only portions of the hydrogen atoms in said alkyl group are replaced with fluorine atoms and can be represented as a fluorinated alkyl of formula C_{q}HₓF_{y}” and means that a portion of hydrogen atoms in said alkyl group are replaced with fluorine atoms, where total number of carbon atoms is designated by q and the sum of x and y is 2q+1. Generally, there is at least one fluorine atom in said alkyl. Thus, for example, when n=1, there can be one, two or three fluorine atoms, and one or two hydrogen atoms. Illustrative examples include monofluoromethyl, difluoromethyl, trifluoromethyl, and the like.

As used herein, the expression “(C₆-C₁₀)aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “(C₆-C₁₀)aryl(C₁-C₄)alkyl” means that the (C₆-C₁₀)aryl as defined herein is further attached to (C₁-C₄)alkyl as defined herein. Representative examples include benzyl, phenylethyl, 2-phenylpropyl, 1-naphthylmethyl, 2-naphthylmethyl and the like.

As used herein “heteroaryl” means a group or part of a group which is an aromatic monocyclic or bicyclic moiety of 5 to 10 ring atoms in which one or more, for example, one, two, or three, of the ring atom(s) is(are) selected from nitrogen, oxygen or sulfur, the remaining ring atoms being carbon. Representative heteroaryl rings include, but are not limited to, pyrrolyl, furanyl, thienyl, oxazolyl, isoxazolyl, thiazolyl, imidazolyl, triazolyl, tetrazolyl, pyridinyl, pyrimidinyl, pyrazinyl, pyridazinyl, indolyl, benzofuranyl, benzothiophenyl, thiophenyl, benzimidazolyl, quinolinyl, isoquinolinyl, quinazolinyl, quinoxalinyl, pyrazolyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of alkyl, alkenyl, perfluoro- or partially fluorinated alkyl, phenyl, hydroxy, —CO₂H, an ester, an amide, alkoxy, thioalkyl and perfluoroalkoxy. However, any of the other suitable substituents known to one skilled in the art can also be used in these embodiments.

It should be noted that any atom with unsatisfied valences in the text, schemes, examples and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

By the term “derived” is meant that the polymeric repeating units are polymerized (formed) from, for example, polycyclic norbornene-type monomers in accordance with formulae (I) to (IV) wherein the resulting polymers are formed by 2,3 enchainment of norbornene-type monomers as shown below:

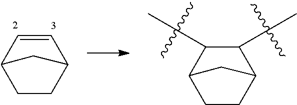

Accordingly, in accordance with the practice of this invention there is provided a single component composition comprising:
a) a palladium compound of formula (I):

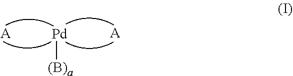

wherein:
a is an integer from 1 to 4, inclusive;
B is a heteroaromatic compound containing at least one nitrogen atom selected from the group consisting of substituted or unsubstituted pyridine, substituted or unsubstituted bipyridine, substituted or unsubstituted pyrazine, substituted or unsubstituted pyrimidine, substituted or unsubstituted pyridazine and substituted or unsubstituted oxazole, where each of the substituent is independently selected from the group consisting of methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl;
each A independently is a bidentate monoanionic ligand of formula (IA):

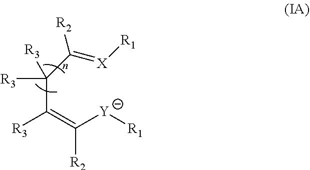

wherein:
n is an integer 0, 1 or 2;
X and Y are independently of each other selected from O, N and S;
R₁, R₂ and R₃ are the same or different and each independently selected from the group consisting of hydrogen, methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl; provided when either X or Y is O or S, R₁ does not exist;
b) a photoacid generator selected from the group consisting of:
a compound of formula (II):

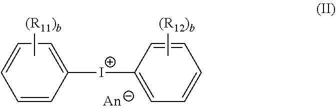

and
a compound of formula (III):

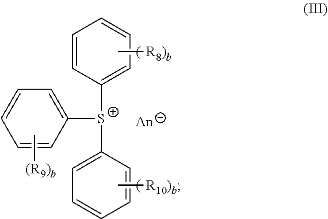

wherein:
b is an integer from 1 to 5, inclusive;
An^{⊖} is selected from the group consisting of Cl^{⊖}, Br^{⊖}, I^{⊖}, BF₄^{⊖}, tetrakis(pentafluorophenyl)borate, tetrakis(3,5-bis(trifluoromethyl)phenyl)borate, tetrakis(2-fluorophenyl)borate, tetrakis(3-fluorophenyl)borate, tetrakis(4-fluorophenyl)borate, tetrakis(3,5-difluorophenyl)borate, tetrakis(2,3,4,5-tetrafluorophenyl)borate, tetrakis(3,4,5,6-tetrafluorophenyl)borate, tetrakis(3,4,5-trifluorophenyl)borate, methyltris(perfluorophenyl)borate, ethyltris(perfluorophenyl)borate, phenyltris(perfluorophenyl)borate, tetrakis(1,2,2-trifluoroethylenyl)borate, tetrakis(4-tri-1-propylsilyltetrafluorophenyl)borate, tetrakis(4-dimethyl-tert-butylsilyltetrafluorophenyl)borate, (triphenylsiloxy)tris(pentafluorophenyl)borate, (octyloxy)tris(pentafluorophenyl)borate, tetrakis[3,5-bis[1-methoxy-2,2,2-trifluoro-1-(trifluoromethyl)ethyl]pheny-1]borate, tetrakis[3-[1-methoxy-2,2,2-trifluoro-1-(trifluoromethyl)ethyl]-5-(trifluoromethyl)phenyl]borate, and tetrakis[3-[2,2,2-trifluoro-1-(2,2,2-trifluoroethoxy)-1-(trifluoromethyl)-ethyl]-5-(trifluoromethyl)phenyl]borate, PF₆^{⊖}, SbF₆^{⊖}, n-C₄F₉SO₃^{⊖}, CF₃SO₃^{⊖}, p-CH₃(C₆H₄)—SO₃^{⊖}, (CF₃SO₂)CH^{⊖} and (CF₃SO₂)N^{⊖};
R₈, R₉, R₁₀, R₁₁ and R₁₂ are the same or different and each independently selected from the group consisting of halogen, methyl, ethyl, linear or branched (C₃-C₂₀)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl, (C₆-C₁₀)-aryloxy, (C₆-C₁₀)thioaryl, (C₁-C₆)alkanoyl(C₆-C₁₀)thioaryl, (C₁-C₆)alkoxy(C₆-C₁₀)aroyl(C₁-C₆)alkyl and (C₆-C₁₀)thioaryl-(C₆-C₁₀)diarylsulfonium salt;
c) one or more olefinic monomers of formula (IV):

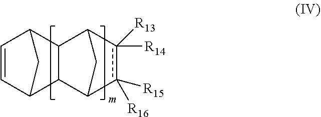

wherein:
m is an integer 0, 1 or 2;
[symbol] is a single bond or a double bond;
R₁₃, R₁₄, R₁₅ and R₁₆ are the same or different and each independently selected from the group consisting of hydrogen, halogen, a hydrocarbyl or halohydrocarbyl group selected from methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, epoxy, epoxy(C₁-C₁₂)alkyl, epoxy(C₁-C₁₂)alkoxy(C₁-C₁₂)alkyl, (C₃-C₁₂)cycloalkyl, epoxy(C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, (C₁-C₁₆)alkoxy(C₁-C₁₂)alkyl, perfluoro(C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy, (C₆-C₁₀)aryl(C₁-C₆)alkoxy, perfluoro(C₆-C₁₀)aryloxy, perfluoro(C₆-C₁₀)aryl(C₁-C₃)alkoxy,
a group of formula (A):

—Z-Aryl (A);
a group of formula (A1):

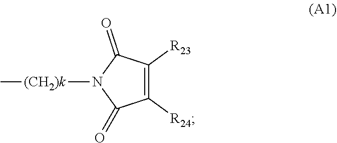

a group of formula (A2):

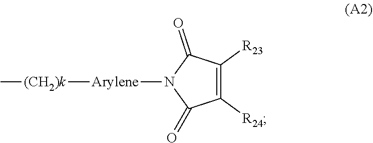

a group of formula (A3):

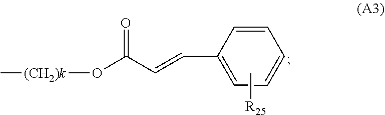

and
a group of formula (A4):

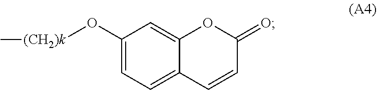

wherein:
Z is selected from the group consisting of:
O, CO, C(O)O, OC(O), OC(O)O, S, (CR₁₇R₁₈)_{d}, O(CR₁₇R₁₈)_{d}, (CR₁₇R₁₈)_{d}O, C(O)(CR₁₇R₁₈)_{d}, (CR₁₇R₁₈)_{d}C(O), C(O)O(CR₁₇R₁₈)_{d}, (CR₁₇R₁₈)_{d}C(O)O, OC(O)(CR₁₇R₁₈)_{d}, (CR₁₇R₁₈)_{d}OC(O), (CR₁₇R₁₈)_{d}OC(O)O, (CR₁₇R₁₈)_{d}OC(O)O(CR₁₇R₁₈)_{d}, OC(O)O(CR₁₇R₁₈)_{d}, S(CR₁₇R₁₈)_{d}, (CR₁₇R₁₈)_{d}S, (SiR₁₇R₁₈)_{d}, O(SiR₁₇R₁₈)_{d}, and (SiR₁₇R₁₈)_{d}O, where
R₁₇ and R₁₈ are the same or different and each independently selected from hydrogen, methyl, ethyl, linear or branched (C₃-C₁₂)alkyl, substituted or unsubstituted (C₆-C₁₄)aryl, methoxy, ethoxy, linear or branched (C₃-C₆)alkyloxy, (C₂-C₆)acyl, (C₂-C₆)acyloxy, and substituted or unsubstituted (C₆-C₁₄)aryloxy; and
d is an integer from 0 to 12, inclusive;
Aryl is selected from the group consisting of substituted or unsubstituted phenyl, substituted or unsubstituted biphenyl and substituted or unsubstituted naphthyl, substituted or unsubstituted terphenyl, substituted or unsubstituted anthracenyl substituted or unsubstituted fluorenyl, wherein the substituents are selected from the group consisting of halogen, methyl, ethyl, linear or branched (C₃-C₆)alkyl, perfluoro(C₁-C₁₂)alkyl, (C₃-C₁₂)cycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, perfluoro(C₁-C₁₂)alkoxy, (C₃-C₁₂)cycloalkoxy, (C₆-C₁₀)aryloxy, (C₆-C₁₀)aryl(C₁-C₆)alkoxy, perfluoro(C₆-C₁₀)aryloxy and perfluoro(C₆-C₁₀)aryl(C₁-C₃)alkoxy;
k is an integer from 1 to 12, inclusive;
R₂₃, R₂₄ and R₂₅ are the same or different and each independently selected from the group consisting of hydrogen, methyl, ethyl, linear or branched (C₃-C₁₂)alkyl, a fluorinated alkyl of formula C_{q}HₓF_{y}, where q is from 1 to 16, x is from 0 to 32, y is from 1 to 33 and sum of x+y=2q+1, methoxy, ethoxy, linear or branched (C₃-C₁₂)alkoxy, (C₃-C₁₂)alkoxy(C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl and perfluoro(C₆-C₁₀)aryl(C₁-C₆)alkyl; or
R₂₃ and R₂₄ taken together with the intervening carbon atoms to which they are attached to form a substituted or unsubstituted (C₅-C₁₄)cyclic, (C₅-C₁₄)bicyclic or (C₅-C₁₄)tricyclic ring; and Arylene is substituted or unsubstituted bivalent (C₆-C₁₄)aryl;
or one of R₁₃ and R₁₄ taken together with one of R₁₅ and R₁₆ and the carbon atoms to which they are attached to form a substituted or unsubstituted (C₅-C₁₄)cyclic, (C₅-C₁₄)bicyclic or (C₅-C₁₄)tricyclic ring;
and
d) a photosensitizer.

More specifically, the Aryl as defined herein is substituted or unsubstituted biphenyl of formula:
a) substituted or unsubstituted phenyl of formula:

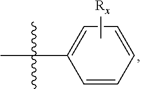

b) substituted or unsubstituted biphenyl of formula:

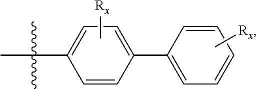

c) substituted or unsubstituted naphthyl of formula:

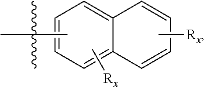

d) substituted or unsubstituted terphenyl of formula:

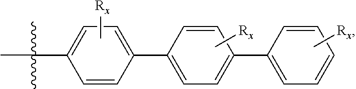

e) substituted or unsubstituted anthracenyl of formula:

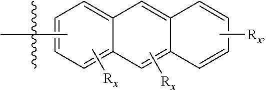

f) substituted or unsubstituted fluorenyl of formula:

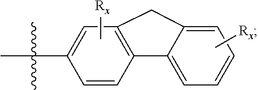

where Rₓ in each occurrence is independently selected from methyl, ethyl, linear or branched (C₃-C₁₂)alkyl or (C₆-C₁₀)aryl.

As defined hereinabove, B is a nitrogen containing heteroaromatic compound, which is coordinately bonded to palladium. That is, any of the heteroaromatic compound which is capable of bonding to palladium by sharing both of its lone pair of electrons of the nitrogen atoms can be used in forming the compound of formula (I). Accordingly, any of such nitrogen containing heteroaromatic compound known in the art can be used for this purpose. The palladium compound of formula (I) can have one to four heteroaromatic compounds coordinately bonded to palladium. Advantageously, it has now been found that such a compound of formula (I) is very stable and dormant even in the presence of one or monomer of formula (I), thus providing practical advantages in storing the composition of this invention for several days even in the presence of air.

Accordingly, the number of nitrogen containing heteroaromatic compounds coordinately bonded to palladium can be one to four molecules. That is, a is an integer ranging from 1 to 4. In some embodiments the number of nitrogen containing heteroaromatic compounds coordinately bonded to palladium is one. In yet some other embodiments the number of nitrogen containing heteroaromatic compounds coordinately bonded to palladium is two. In yet some other embodiments the number of nitrogen containing heteroaromatic compounds coordinately bonded to palladium is three. In yet some other embodiments the number of nitrogen containing heteroaromatic compounds coordinately bonded to palladium is four. However, it should be noted that in some embodiments more than four such heteroaromatic compounds can be coordinately bonded to palladium. All such possible combinations are part of this invention. It should further be noted that any of below noted specific nitrogen containing heteroaromatic compounds can be used in any combination thereof to form a palladium compound of formula (I) having one to four such nitrogen containing heteroaromatic compounds.

It is even more advantageous to know that the composition of this invention is found to be more stable than a few of similar compositions known in the prior art and yet are very active when subjected to suitable actinic radiation. For example, U. S. Patent Application Publication US2021/0198392 A1 discloses certain compositions, which undergo mass polymerization in the presence of Pd(AcAc)₂ based catalysts. However, it has now been found that the compositions of this invention exhibit much superior shelf-life stability than the compositions disclosed therein. Similarly, the compositions disclosed in U.S. Pat. No. 11,746,166 B2, which utilizes Pd(AcAc)₂L based catalysts, where L is a phosphine, also exhibit not so long shelf-life stability but also are less active in the presence of air. Surprisingly, the compositions of this invention are active even in the presence of air, thus eliminating the need of inert atmospheric conditions during the fabrication of a device, thus further offering cost benefits. Finally, the compositions of this invention are also found to exhibit superior performance when compared with the compositions reported in U.S. Pat. No. 11,299,566 B2, where a hindered amine is used to stabilize the compositions reported therein. The compositions reported therein are also not active in the presence of air especially for forming thin films of about one m thickness. Therefore, the compositions of this invention provide much needed beneficial advantages over the compositions of the prior art.

Accordingly, it has now been found that various suitable heteroaromatic compounds can be employed to form the compound of formula (I). Representative examples of substituted pyridine, include without any limitation, monosubstituted pyridines, such as, 2-methylpyridine, 3-methylpyridine, 4-methylpyridine, 2-ethylpyridine, 3-ethylpyridine, 4-ethylpyridine, 2-methoxypyridine, 3-methoxypyridine and 4-methoxypyridine. Di-substituted pyridines, such as, 2,3-dimethylpyridine, 2,4-dimethylpyridine, 2,5-dimethylpyridine, 2,6-dimethylpyridine, 3,4-dimethylpyridine, 3,5-dimethylpyridine, 2,6-di-t-butylpyridine, and 2,4-di-t-butylpyridine. Tri-substituted pyridines, such as, 2,3,4-trimethylpyridine, 2,3,5-trimethylpyridine, 2,3,6-trimethylpyridine, 2,4,6-trimethylpyridine, 3,4,5-trimethylpyridine, 3,4,6-trimethylpyridine and 2,4,6-tri-isopropylpyridine.

Representative examples of substituted bipyridine, include without any limitation, monosubstituted bipyridines, such as, 2-methyl-4,4′-bipyridine, 3-methyl-4,4′-bipyridine, 4-methyl-4,4′-bipyridine, 2′-methyl-4,4′-bipyridine, 3′-methyl-4,4′-bipyridine, 4′-methyl-4,4′-bipyridine, 2-ethyl-4,4′-bipyridine and 4-ethyl-4,4′-bipyridine. Di-substituted bipyridines, such as, 2,3-dimethyl-4,4′-bipyridine, 2,4-dimethyl-4,4′-bipyridine, 4,4′-dimethyl-4,4′-bipyridine, 2,2′-dimethyl-4,4′-bipyridine, 3,3′-dimethyl-4,4′-bipyridine, 2,4′-methyl-4,4′-bipyridine, 2,2′-diethyl-4,4′-bipyridine and 4,4′-diethyl-4,4′-bipyridine. Tri-substituted bipyridines, such as, 2,3,4-trimethyl-4,4′-bipyridine, 2,3,5-trimethyl-4,4′-bipyridine, 2,3,6-trimethyl-4,4′-bipyridine, 2,4,6-trimethyl-4,4′-bipyridine, 3,4,5-trimethyl-4,4′-bipyridine, 3,4,6-trimethyl-4,4′-bipyridine and 2,4,6-tri-isopropyl-4,4′-bipyridine. Tetra-substituted bipyridines, such as, 2,2′,6,6′-tetramethyl-4,4′-bipyridine, 2,6-dimethyl-2′,6′-diethyl-4,4′-bipyridine and 2,6-dimethyl-2′,6′-diisopropyl-4,4′-bipyridine.

Representative examples of substituted pyrazine, include without any limitation, monosubstituted pyrazines, such as, 2-methylpyrazine, 3-methylpyrazine, 2-ethylpyrazine and 3-ethylpyrazine. Di-substituted pyrazines, such as, 2,3-dimethylpyrazine and 2,3-diethyl-pyrazine. Tri-substituted pyrazines, such as, 2,3,5-trimethylpyrazine and 2,3,5-triethyl-pyrazine. Tetra-substituted pyrazines, such as, 2,3,5,6-tetramethylpyrazine, 2,3-dimethyl-5,6-diethyl-pyrazine and 2,3-dimethyl-5,6-diisopropylpyrazine.

Representative examples of substituted pyrimidine, include without any limitation, monosubstituted pyrimidines, such as, 2-methylpyrimidine, 4-methylpyrimidine, 2-ethyl pyrimidine and 4-ethylpyrazine. Di-substituted pyrimidines, such as, 2,4-dimethylpyrimidine and 2,4-diethylpyrimidine. Tri-substituted pyrimidines, such as, 2,4,6-trimethylpyrimidine and 2,4,5-triethylpyrimidine. Tetra-substituted pyrimidines, such as, 2,4,5,6-tetramethylpyrimidine, 2,4-dimethyl-5,6-diethylpyrimidine and 2,4-dimethyl-5,6-diisopropylpyrimidine.

Representative examples of substituted pyridazine, include without any limitation, monosubstituted pyridazines, such as, 3-methylpyridazine, 4-methylpyridazine, 2-ethylpyridazine and 4-ethylpyridazine. Di-substituted pyridazines, such as, 3,4-dimethylpyridazine and 4,6-diethylpyridazine. Tri-substituted pyridazines, such as, 3,4,5-trimethylpyridazine and 4,5,6-triethylpyridazine. Tetra-substituted pyridazines, such as, 3,4,5,6-tetramethylpyridazine, 3,4-dimethyl-5,6-diethylpyridazine and 3,4-dimethyl-5,6-diisopropylpyridazine.

Representative examples of substituted oxazole, include without any limitation, monosubstituted oxazoles, such as, 2-methyloxazole, 4-methyloxazole and 5-methyloxazole.

Di-substituted oxazoles, such as, 2,4-dimethyloxazole, 2,5-dimethyloxazole and 2,5-diethyloxazole. Tri-substituted oxazoles, such as, 2,4,5-trimethyloxazole, 4-methyl-2,5-diethyloxazole and 4-methyl-2,5-diisopropyloxazole.

Various olefinic monomers which undergo vinyl addition polymerization can be employed in the composition of this invention. Such olefinic monomers include without any limitation alicyclic olefins, such as ethylene, propylene, butylene, styrene, and the like. Other olefinic monomers include cyclo-olefins and bicyclo-olefins, and so on.

In some embodiments of this invention the olefinic monomers which are suitable in the composition of this invention are of the formula (V), wherein:
m=0 or 1;
[symbol] is a single bond;
at least one of R₁₃, R₁₄, R₁₈ and R₁₆ is selected from the group consisting of n-hexyl, n-heptyl, n-octyl, n-nonyl, n-decyl, n-dodecyl, phenylbutyl, phenoxyethyl, biphenyloxyethyl and biphenyloxybutyl.

The monomers of formula (V) as described herein are themselves known in the literature or can be prepared by any of the known methods in the art to make such or similar types of monomers.

In addition, the monomers as described herein readily undergo mass vinyl addition polymerization, i.e., in their neat form without use of any solvents by vinyl addition polymerization using transition metal procatalysts, such as for example, a palladium compound of formula (I) as described herein. See for example, U.S. Pat. Nos. 7,442,800 B2; and 7,759,439 B2; pertinent portions of which are incorporated herein by reference. The term “mass polymerization” as used herein shall have the generally accepted meaning in the art. That is, a polymerization reaction that is generally carried out substantially in the absence of a solvent. In some cases, however, a small proportion of solvent is present in the reaction medium. For example, such small amounts of solvent may be used to dissolve the palladium compound of formula (I) and/or a photoacid generator or photosensitizer as described herein or convey the same to the reaction medium. Also, some solvent may be used to reduce the viscosity of the monomer. The amount of solvent that can be used in the reaction medium may be in the range of 0 to 5 weight percent based on the total weight of the monomers employed. Any of the suitable solvents that dissolves the palladium compound of formulae (I), a photoacid generator or photosensitizer and/or monomers can be employed in this invention. Examples of such solvents include alkanes, cycloalkanes, aromatics, such as toluene, ester solvents such as ethyl acetate, tetrahydrofuran (THF), dichloromethane, dichloroethane, and the like.

Advantageously, it has now been found that one or more of the monomers themselves can be used to dissolve the palladium compound of formulae (I) or a photoacid generator or photosensitizer and thus avoiding the need for the use of solvents. In addition, one monomer can itself serve as a solvent for the other monomer and thus eliminating the need for an additional solvent. For example, if a first monomer of formula (IV) is a solid at room temperature, then a second monomer of formula (IV), which is a liquid at room temperature can be used as a solvent for the first monomer of formula (IV) which is a solid or vice versa. Therefore, in such situations more than one monomer can be employed in the composition of this invention.

In some embodiments, the monomers of formula (IV) employed in the composition of this invention may serve as high refractive index materials imparting high (or low) refractive index to the resulting polymeric film upon mass polymerization. In general, the monomers of formula (IV) which are suitable in this invention feature a refractive index of at least 1.5. In some embodiments the refractive index of the monomers of formula (IV) is higher than 1.5. In some other embodiments the refractive index of the monomers of formula (IV) is in the range from about 1.5 to 1.6. In yet some other embodiments the refractive index of the monomers of formula (IV) is higher than 1.55, higher than 1.6 or higher than 1.65. In some other embodiments it may even be higher than 1.7.

In some other embodiments the composition contains one or more monomers of formula (IV) for forming low dielectric compositions. For example, as already discussed above, by employing proper combination of different monomers of formula (IV) it is now possible to tailor a composition having the desirable low dielectric properties and thermo-mechanical properties, among other properties. In addition, it may be desirable to include other polymeric or monomeric materials which are compatible to provide desirable low-loss and low dielectric properties depending upon the end use application as one of skill in the art may readily appreciate.

In some other embodiments, it is generally contemplated that monomer of formula (IV) may also be used as a viscosity modifier. Accordingly, in general, such a monomer of formula (IV) is a liquid at room temperature and can be used in conjunction with another monomer of formula (IV) which is a solid or a high viscosity liquid.

In a further embodiment of this invention the composition of this invention encompasses at least two different monomers of formula (IV) and is in a clear liquid state having a viscosity below 100 centipoise. In general, the composition of this invention exhibits low viscosity, which can be below 100 centipoise. In some embodiments, the viscosity of the composition of this invention is less than 90 centipoise. In some other embodiments the viscosity of the composition of this invention is in the range from about 5 to 100 centipoise. In yet some other embodiments the viscosity of the composition of this invention is lower than 80 cP, lower than 60 cP, lower than 40 cP, lower than 20 cP, lower than 10 cP. In some other embodiments it may even be lower than 10 cP.

When the composition of this invention contains two monomers, they can be present in any desirable amounts that would bring about the intended benefit, including either refractive index modification or viscosity modification or both or any other desirable property depending upon the intended final application. Accordingly, the molar ratio of first monomer of formula (IV) to second monomer of formula (IV) can be from 0:100 to 100:0. That is, only one monomer of formula (IV) can be employed in certain applications. In other words, any amount of these two monomers can be employed. In some embodiments, the molar ratio of first monomer of formula (IV):second monomer of formula (IV) is in the range from 1:99 to 99:1; in some other embodiments it is from 5:95 to 95:5; it is from 10:90 to 90:10; it is from 20:80 to 80:20; it is from 30:70 to 70:30; it is from 60:40 to 40:60; and it is 50:50, and so on.

In general, the compositions in accordance with the present invention encompass the above described one or more of monomer of formula (IV), as it will be seen below, various composition embodiments are selected to provide properties to such embodiments that are appropriate and desirable for the use for which such embodiments are directed, thus such embodiments are tailorable to a variety of specific applications. Accordingly, in some embodiments the composition of this invention contains more than two distinct monomers of formula (IV), such as for example three different monomers of formula (IV) or four different monomers of formula (IV).

For example, as already discussed above, proper combination of different monomers of formula (IV) makes it possible to tailor a composition having the desirable refractive index, viscosity and optical transmission properties, among other properties. In addition, it may be desirable to include other polymeric or monomeric materials which are compatible to provide desirable optical properties depending upon the end use application. Accordingly, the compositions of this invention can also include other high or low refractive polymeric materials which will bring about such intended benefit. Examples of such polymers include without any limitation, poly(a-methylstyrene), poly(vinyl-toluene), copolymers of a-methylstyrene and vinyl-toluene, and the like.

Advantageously, it has further been found that the compositions of this invention can also contain additional monomers different from the monomer of formula (IV). In some embodiments, the composition according to this invention may further contain one or more monomers selected from monomer of formula (V) or monomer of formula (VI).

The monomer of formula (V) is:

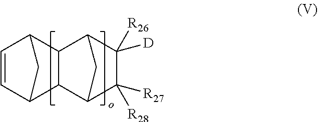

wherein:
o is an integer from 0 to 2, inclusive;
D is SiR₂₉R₃₀R₃₁ or a group selected from:
   —(CH₂)_{c}—O—SiR₂₉R₃₀R₃₁ (E);
   —(CH₂)_{c}—SiR₂₉R₃₀R₃₁ (F); and
   —(SiR₂₉R₃₀)_{c}—O—SiR₂₉R₃₀R₃₁ (G); wherein
c is an integer from 1 to 10, inclusive, and where one or more of CH₂ is optionally substituted with (C₁-C₁₀)alkyl or (C₁-C₁₀)perfluoroalkyl;
R₂₆, R₂₇ and R₂₈ are the same or different and independently of each other selected from hydrogen, halogen and hydrocarbyl, where hydrocarbyl is selected from methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl or (C₆-C₁₀)aryloxy; and
R₂₉, R₃₀ and R₃₁ are each independently of one another methyl, ethyl, linear or branched (C₃-C₉)alkyl, substituted or unsubstituted (C₆-C₁₄)aryl, methoxy ethoxy, linear or branched (C₃-C₉)alkoxy or substituted or unsubstituted (C₆-C₁₄)aryloxy.

In this aspect of the invention, it has now been found that monomers of formula (V) provides further advantages. Namely, the monomers of formula (V) depending upon the nature of the monomer may impart high or low refractive index to the composition, thus it can be tailored to meet the need. In addition, the monomers of formula (V) generally improve the adhesion properties and thus can be used as “adhesion modifiers.” Finally, the monomers of formula (V) may exhibit low viscosity and good solubility for palladium compound of formula (I) and/or photoacid generator of formulae (II) and (III), among various other advantages.

The monomer of formula (VI) is:

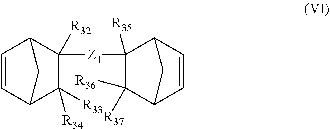

wherein:
Z₁ is selected from the group consisting of substituted or unsubstituted (C₁-C₁₂)alkylene, —(CH₂)ₑO(CH₂)_{f}—, —(CH₂)ₑ(SiR₃₈R₃₉)(OSiR₄₀R₄₁)_{g}(CH₂)_{f}— where e, f and g are independently integers from 0 to 6, inclusive, R₃₈, R₃₉, R₄₀ and R₄₁ are the same or different and independently of each other selected from methyl, ethyl, linear or branched (C₃-C₁₂)alkyl, and an arylene selected from the following:

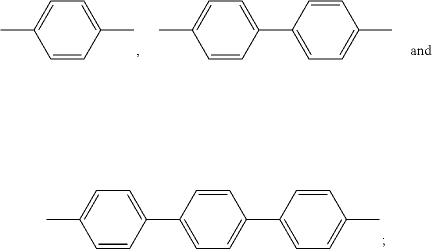

R₃₂, R₃₃, R₃₄, R₃₅, R₃₆ and R₃₇ are the same or different and independently of each other selected from hydrogen, halogen and hydrocarbyl, where hydrocarbyl is selected from methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl or (C₆-C₁₀)-aryloxy.

The monomers of formula (VI) are bifunctional monomers and may exhibit high refractive index especially when Z₁ is an arylene group. Accordingly, it is contemplated that incorporation of monomers of formula (VI) into composition of this invention generally increases the refractive index of the composition and also increase crosslinkability with other molecules. Thus, by incorporation of monomers of formula (VI) into the composition of this invention it may be possible to increase compatibility with other materials depending upon the intended application thereby enhancing the properties of the composition of the invention.

In another aspect of this invention, it is conceivable that the composition of this invention may contain only one monomer of formula (IV) or formula (V) or formula (VI). That is, any one of the monomers of formulae (IV), (V) or (VI) may be sufficient to form a composition of this invention. In some other embodiments the composition of this invention encompasses any two monomers of formulae (IV), (V) or (VI) and in any desirable proportions. In some other embodiments the composition of this invention encompasses any three monomers of formulae (IV), (V) or (VI) in any combinations thereof and in any desirable proportions. All such possible permutations and combinations of monomers of formulae (IV), (V) or (VI) are part of this invention. In some embodiments the composition of this invention encompasses at least one monomer of formula (IV) in combination with one or more monomers of formulae (V) or (VI) in any combinations thereof and in any desirable proportions.

Accordingly, any of the monomers within the scope of monomer of formula (IV) can be employed in the composition of the invention. Representative examples of monomer of formula (IV) include the following without any limitations:

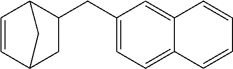 [SMILES: C1=CC2CC1CC2Cc1ccc2ccccc2c1]

2-(bicyclo[2.2.1]hept-5-en-2-ylmethyl)naphthalene;

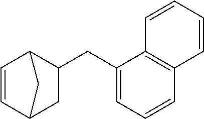 [SMILES: C1=CC2CC1CC2Cc1cccc2ccccc12]

1-(bicyclo[2.2.1]hept-5-en-2-ylmethyl)naphthalene;

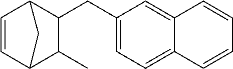 [SMILES: CC1C2C=CC(C2)C1Cc1ccc2ccccc2c1]

2-((3-methylbicyclo[2.2.1]hept-5-en-2-yl)methyl)naphthalene;

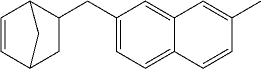 [SMILES: Cc1ccc2ccc(CC3CC4C=CC3C4)cc2c1]

2-(bicyclo[2.2.1]hept-5-en-2-ylmethyl)-7-methylnaphthalene;

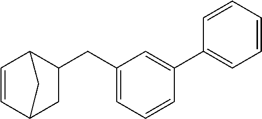 [SMILES: C1=CC2CC1CC2Cc1cccc(-c2ccccc2)c1]

5-([1,1′-biphenyl]-3-ylmethyl)bicyclo[2.2.1]hept-2-ene;

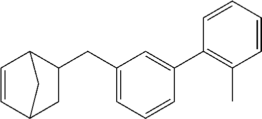 [SMILES: Cc1ccccc1-c1cccc(CC2CC3C=CC2C3)c1]

5-((2′-methyl-[1,1′-biphenyl]-3-yl)methyl)bicyclo[2.2.1]hept-2-ene;

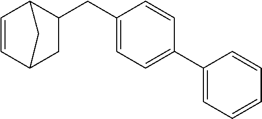 [SMILES: C1=CC2CC1CC2Cc1ccc(-c2ccccc2)cc1]

5-([1,1′-biphenyl]-4-ylmethyl)bicyclo[2.2.1]hept-2-ene:

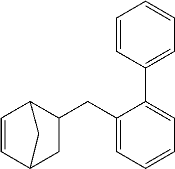 [SMILES: C1=CC2CC1CC2Cc1ccccc1-c1ccccc1]

5-([1,1′-biphenyl]-2-ylmethyl)bicyclo[2.2.1]hept-2-ene;

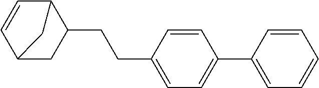 [SMILES: C1=CC2CC1CC2CCc1ccc(-c2ccccc2)cc1]

5-(2-([1,1′-biphenyl]-4-yl)ethyl)bicyclo[2.2.1]hept-2-ene (NBEtPhPh);

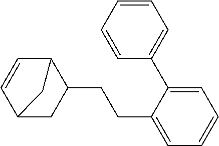 [SMILES: C1=CC2CC1CC2CCc1ccccc1-c1ccccc1]

5-(2-([1,1′-biphenyl]-2-yl)ethyl)bicyclo[2.2.1]hept-2-ene;

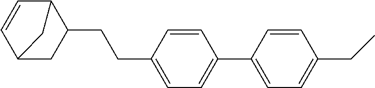 [SMILES: CCc1ccc(-c2ccc(CCC3CC4C=CC3C4)cc2)cc1]

5-(2-(4′-ethyl-[1,1′-biphenyl]-4-yl)ethyl)bicyclo[2.2.1]hept-2-ene;

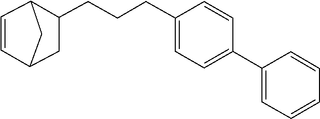 [SMILES: C1=CC2CC1CC2CCCc1ccc(-c2ccccc2)cc1]

5-(3-([1,1′-biphenyl]-4-yl)propyl)bicyclo[2.2.1]hept-2-ene;

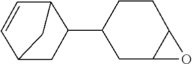 [SMILES: C1=CC2CC1CC2C1CCC2OC2C1]

3-(bicyclo[2.2.1]hept-5-en-2-yl)-7-oxabicyclo[4.1.0]heptane (CHEpNB);

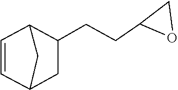 [SMILES: C1=CC2CC1CC2CCC1CO1]

2-(2-(bicyclo[2.2.1]hept-5-en-2-yl)ethyl)oxirane (EBNB);

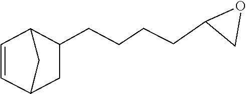 [SMILES: C1=CC2CC1CC2CCCCC1CO1]

2-(4-(bicyclo[2.2.1]hept-5-en-2-yl)butyl)oxirane (EHNB);

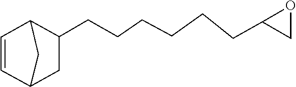 [SMILES: C1=CC2CC1CC2CCCCCCC1CO1]

2-(6-(bicyclo[2.2.1]hept-5-en-2-yl)hexyl)oxirane (EONB);

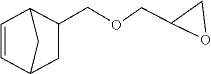 [SMILES: C1=CC2CC1CC2COCC1CO1]

2-((bicyclo[2.2.1]hept-5-en-2-ylmethoxy)methyl)oxirane (MGENB);

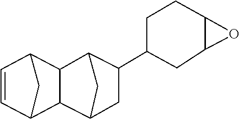 [SMILES: C1=CC2CC1C1C3CC(C4CCC5OC5C4)C(C3)C21]

3-(1,2,3,4,4a,5,8,8a-octahydro-1,4:5,8-dimethanonaphthalen-2-yl)-7-oxabicyclo[4.1.0]heptane (CHEpTD);

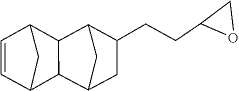 [SMILES: C1=CC2CC1C1C3CC(CCC4CO4)C(C3)C21]

2-(2-(1,2,3,4,4a,5,8,8a-octahydro-1,4:5,8-dimethanonaphthalen-2-yl)ethyl)oxirane (EBTD);

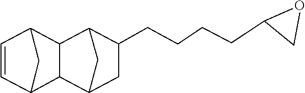 [SMILES: C1=CC2CC1C1C3CC(CCCCC4CO4)C(C3)C21]

2-(4-(1,2,3,4,4a,5,8,8a-octahydro-1,4:5,8-dimethanonaphthalen-2-yl)butyl)oxirane (EHTD);

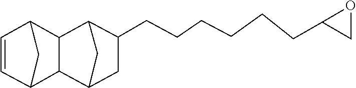 [SMILES: C1=CC2CC1C1C3CC(CCCCCCC4CO4)C(C3)C21]

2-(6-(1,2,3,4,4a,5,8,8a-octahydro-1,4:5,8-dimethanonaphthalen-2-yl)hexyl)oxirane (EOTD);

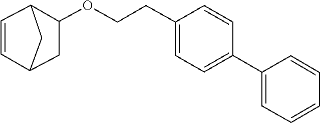 [SMILES: C1=CC2CC1CC2OCCc1ccc(-c2ccccc2)cc1]

5-(2-([1,1′-biphenyl]-4-yl)ethoxy)bicyclo[2.2.1]hept-2-ene;

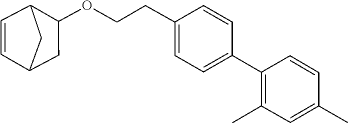 [SMILES: Cc1ccc(-c2ccc(CCOC3CC4C=CC3C4)cc2)c(C)c1]

5-(2-(2′,4′-dimethyl-[1,1′-biphenyl]-4-yl)ethoxy)bicyclo[2.2.1]hept-2-ene;

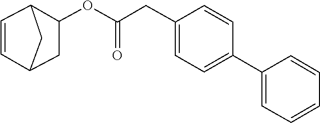 [SMILES: O=C(Cc1ccc(-c2ccccc2)cc1)OC1CC2C=CC1C2]

bicyclo[2.2.1]hept-5-en-2-yl 2-([1,1′-biphenyl]-4-yl)acetate;

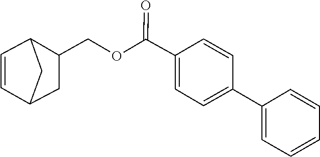 [SMILES: O=C(OCC1CC2C=CC1C2)c1ccc(-c2ccccc2)cc1]

bicyclo[2.2.1]hept-5-en-2-ylmethyl [1,1′-biphenyl]-4-carboxylate;

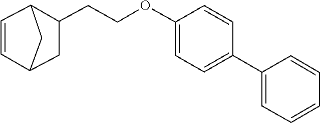 [SMILES: C1=CC2CC1CC2CCOc1ccc(-c2ccccc2)cc1]

5-(2-([1,1′-biphenyl]-4-yloxy)ethyl)bicyclo[2.2.1]hept-2-ene;

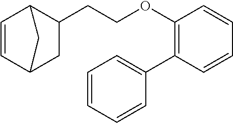 [SMILES: C1=CC2CC1CC2CCOc1ccccc1-c1ccccc1]

5-(2-([1,1′-biphenyl]-2-yloxy)ethyl)bicyclo[2.2.1]hept-2-ene (NBEtOPhPh);

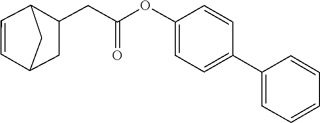 [SMILES: O=C(CC1CC2C=CC1C2)Oc1ccc(-c2ccccc2)cc1]

[1,1′-biphenyl]-4-yl 2-(bicyclo[2.2.1]hept-5-en-2-yl)acetate;

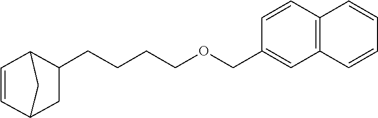 [SMILES: C1=CC2CC1CC2CCCCOCc1ccc2ccccc2c1]

2-((4-(bicyclo[2.2.1]hept-5-en-2-yl)butoxy)methyl)naphthalene;

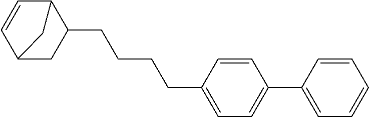 [SMILES: C1=CC2CC1CC2CCCCc1ccc(-c2ccccc2)cc1]

5-(4-([1,1′-biphenyl]-4-yl)butyl)bicyclo[2.2.1]hept-2-ene;

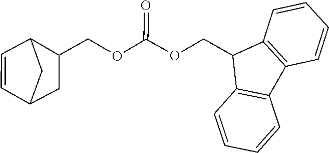 [SMILES: O=C(OCC1c2ccccc2-c2ccccc21)OCC1CC2C=CC1C2]

(9H-fluoren-9-yl)methyl (bicyclo[2.2.1]hept-5-en-2-ylmethyl) carbonate;

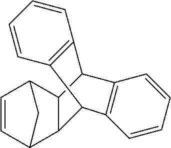 [SMILES: C1=CC2CC1C1C3c4ccccc4C(c4ccccc43)C21]

(9R,10S,11R,12S)-9,10-dihydro-9,10-[2]bicycloanthracene;

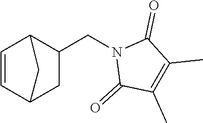 [SMILES: CC1=C(C)C(=O)N(CC2CC3C=CC2C3)C1=O]

1-(4-bicyclo[2.2.1]hept-5-en-2-ylmethyl)-3,4-dimethyl-1H-pyrrole-2,5-dione (MeDMMINB);

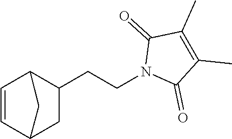 [SMILES: CC1=C(C)C(=O)N(CCC2CC3C=CC2C3)C1=O]

1-(4-bicyclo[2.2.1]hept-5-en-2-ylethyl)-3,4-dimethyl-1H-pyrrole-2,5-dione (EtDMMINB);

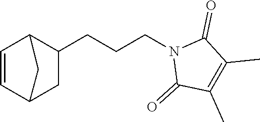 [SMILES: CC1=C(C)C(=O)N(CCCC2CC3C=CC2C3)C1=O]

1-(4-bicyclo[2.2.1]hept-5-en-2-ylpropyl)-3,4-dimethyl-1H-pyrrole-2,5-dione (PrDMMINB);

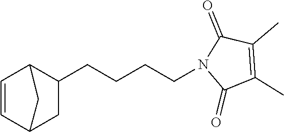 [SMILES: CC1=C(C)C(=O)N(CCCCC2CC3C=CC2C3)C1=O]

1-(4-bicyclo[2.2.1]hept-5-en-2-ylbutyl)-3,4-dimethyl-1H-pyrrole-2,5-dione (BuDMMINB);

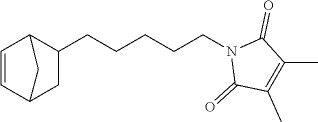 [SMILES: CC1=C(C)C(=O)N(CCCCCC2CC3C=CC2C3)C1=O]

1-(4-bicyclo[2.2.1]hept-5-en-2-ylpentyl)-3,4-dimethyl-1H-pyrrole-2,5-dione (PentylDMMINB);

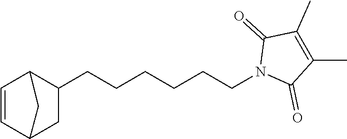 [SMILES: CC1=C(C)C(=O)N(CCCCCCC2CC3C=CC2C3)C1=O]

1-(4-bicyclo[2.2.1]hept-5-en-2-ylhexyl)-3,4-dimethyl-1H-pyrrole-2,5-dione (HxDMMINB);

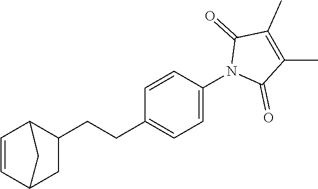 [SMILES: CC1=C(C)C(=O)N(c2ccc(CCC3CC4C=CC3C4)cc2)C1=O]

1-(4-bicyclo[2.2.1]hept-5-en-2-ylethyl)1,4-phenylene-3,4-dimethyl-1H-pyrrole-2,5-dione (EtPhDMMINB);

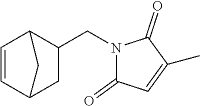 [SMILES: CC1=CC(=O)N(CC2CC3C=CC2C3)C1=O]

1-(4-bicyclo[2.2.1]hept-5-en-2-ylmethyl)-3-methyl-1H-pyrrole-2,5-dione (MeMMINB);

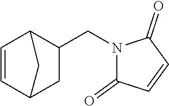 [SMILES: O=C1C=CC(=O)N1CC1CC2C=CC1C2]

1-(4-bicyclo[2.2.1]hept-5-en-2-ylmethyl)-1H-pyrrole-2,5-dione (MeMINB);

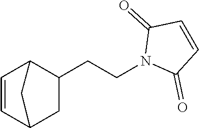 [SMILES: O=C1C=CC(=O)N1CCC1CC2C=CC1C2]

1-(4-bicyclo[2.2.1]hept-5-en-2-ylethyl)-1H-pyrrole-2,5-dione (EtMINB);

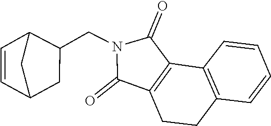 [SMILES: O=C1C2=C(C(=O)N1CC1CC3C=CC1C3)c1ccccc1CC2]

NBDHNMI;

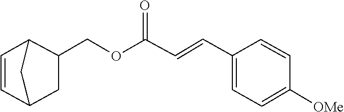 [SMILES: COc1ccc(/C=C/C(=O)OCC2CC3C=CC2C3)cc1]

bicyclo[2.2.1]hept-5-en-2-ylmethyl 4-methoxy-cinnamate (NBMeMeOCinn);

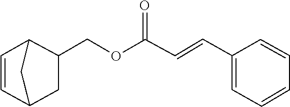 [SMILES: O=C(/C=C/c1ccccc1)OCC1CC2C=CC1C2]

bicyclo[2.2.1]hept-5-en-2-ylmethyl cinnamate (NBMeCinn);

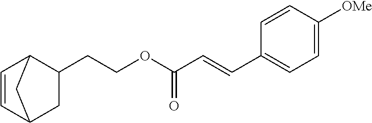 [SMILES: COc1ccc(/C=C/C(=O)OCCC2CC3C=CC2C3)cc1]

bicyclo[2.2.1]hept-5-en-2-ylethyl 4-methoxy-cinnamate (NBEtMeOCinn);

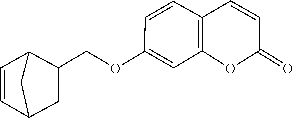 [SMILES: O=c1ccc2ccc(OCC3CC4C=CC3C4)cc2o1]

7-(bicyclo[2.2.1]hept-5-en-2-ylmethoxy)-2H-chromen-2-one (NBMeCoum);

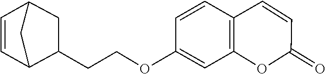 [SMILES: O=c1ccc2ccc(OCCC3CC4C=CC3C4)cc2o1]

7-(2-(bicyclo[2.2.1]hept-5-en-2-yl)ethoxy)-2H-chromen-2-one (NBEtCoum);

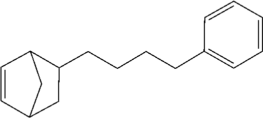 [SMILES: C1=CC2CC1CC2CCCCc1ccccc1]

5-(4-phenylbutyl)bicyclo[2.2.1]hept-2-ene;

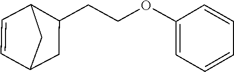 [SMILES: C1=CC2CC1CC2CCOc1ccccc1]

5-(2-phenoxyethyl)bicyclo[2.2.1]hept-2-ene;

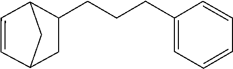 [SMILES: C1=CC2CC1CC2CCCc1ccccc1]

5-(3-phenylpropyl)bicyclo[2.2.1]hept-2-ene;

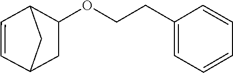 [SMILES: C1=CC2CC1CC2OCCc1ccccc1]

5-phenethoxybicyclo[2.2.1]hept-2-ene;

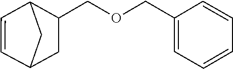 [SMILES: C1=CC2CC1CC2COCc1ccccc1]

5-((benzyloxy)methyl)bicyclo[2.2.1]hept-2-ene;

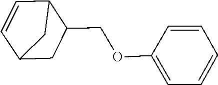 [SMILES: C1=CC2CC1CC2COc1ccccc1]

5-(phenoxymethyl)bicyclo[2.2.1]hept-2-ene;

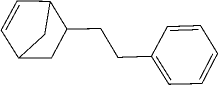 [SMILES: C1=CC2CC1CC2CCc1ccccc1]

5-phenethylbicyclo[2.2.1]hept-2-ene (PENB);

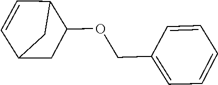 [SMILES: C1=CC2CC1CC2OCc1ccccc1]

5-(benzyloxy)bicyclo[2.2.1]hept-2-ene;

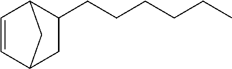

5-hexylbicyclo[2.2.1]hept-2-ene (HexylNB);

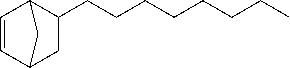

5-octylbicyclo[2.2.1]hept-2-ene (OctNB);

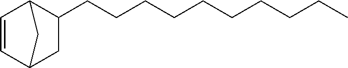 [SMILES: CCCCCCCCCCC1CC2C=CC1C2]

5-decylbicyclo[2.2.1]hept-2-ene (DecNB);

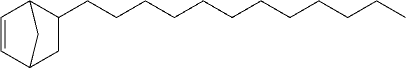 [SMILES: CCCCCCCCCCCCC1CC2C=CC1C2]

5-dodecylbicyclo[2.2.1]hept-2-ene (DoDecNB

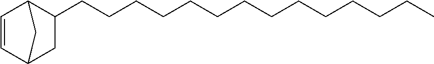 [SMILES: CCCCCCCCCCCCCCC1CC2C=CC1C2]

5-tetradecylbicyclo[2.2.1]hept-2-ene (TetraDecNB);

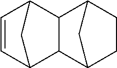 [SMILES: C1=CC2CC1C1C3CCC(C3)C21]

tetracyclododecene (TD);

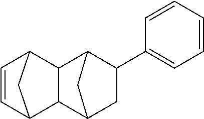 [SMILES: C1=CC2CC1C1C3CC(c4ccccc4)C(C3)C21]

2-phenyl-tetracyclododecene (PhTD);

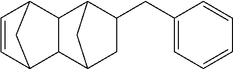 [SMILES: C1=CC2CC1C1C3CC(Cc4ccccc4)C(C3)C21]

2-benzyl-1,2,3,4,4a,5,8,8a-octahydro-1,4:5,8-dimethanonaphthalene;

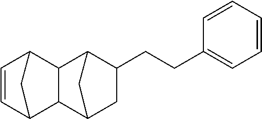 [SMILES: C1=CC2CC1C1C3CC(CCc4ccccc4)C(C3)C21]

2-phenethyl-1,2,3,4,4a,5,8,8a-octahydro-1,4:5,8-dimethanonaphthalene (PETD);

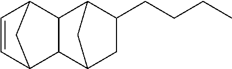 [SMILES: CCCCC1CC2CC1C1C3C=CC(C3)C21]

2-butyl-1,2,3,4,4a,5,8,8a-octahydro-1,4:5,8-dimethanonaphthalene (ButylTD);

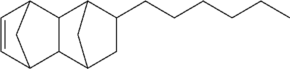 [SMILES: CCCCCCC1CC2CC1C1C3C=CC(C3)C21]

2-hexyl-1,2,3,4,4a,5,8,8a-octahydro-1,4:5,8-dimethanonaphthalene (HexylTD);

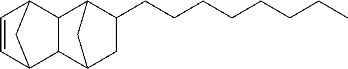 [SMILES: CCCCCCCCC1CC2CC1C1C3C=CC(C3)C21]

2-octyl-1,2,3,4,4a,5,8,8a-octahydro-1,4:5,8-dimethanonaphthalene (OctylTD);

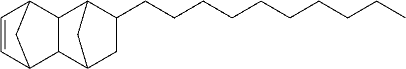 [SMILES: CCCCCCCCCCC1CC2CC1C1C3C=CC(C3)C21]

2-decyl-1,2,3,4,4a,5,8,8a-octahydro-1,4:5,8-dimethanonaphthalene (DecylTD);

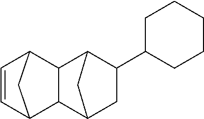 [SMILES: C1=CC2CC1C1C3CC(C4CCCCC4)C(C3)C21]

2-cyclohexyl-tetracyclododecene (CyclohexylTD);

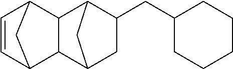 [SMILES: C1=CC2CC1C1C3CC(CC4CCCCC4)C(C3)C21]

2-cyclohexylmethyl-1,2,3,4,4a,5,8,8a-octahydro-1,4:5,8-dimethanonaphthalene;

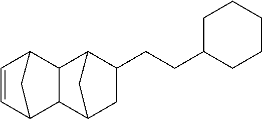 [SMILES: C1=CC2CC1C1C3CC(CCC4CCCCC4)C(C3)C21]

2-cyclohexylethyl-1,2,3,4,4a,5,8,8a-octahydro-1,4:5,8-dimethanonaphthalene; and

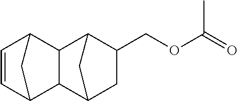 [SMILES: CC(=O)OCC1CC2CC1C1C3C=CC(C3)C21]

(1,2,3,4,4a,5,8,8a-octahydro-1,4:5,8-dimethanonaphthalen-2-yl)methyl acetate (TDMeOAc).

Turning now to monomer of formula (V) to form the composition of this invention it is contemplated that any monomer within the scope of monomer of formula (V) as defined herein can be employed. Exemplary monomers of such type include but not limited to those selected from the group consisting of:

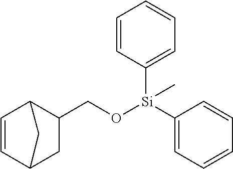 [SMILES: C[Si](OCC1CC2C=CC1C2)(c1ccccc1)c1ccccc1]

(bicyclo[2.2.1]hept-5-en-2-ylmethoxy)(methyl)diphenylsilane (NBCH₂OSiMePh₂);

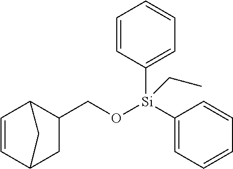 [SMILES: CC[Si](OCC1CC2C=CC1C2)(c1ccccc1)c1ccccc1]

(bicyclo[2.2.1]hept-5-en-2-ylmethoxy)(ethyl)diphenylsilane;

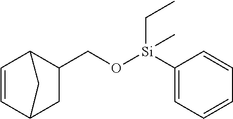 [SMILES: CC[Si](C)(OCC1CC2C=CC1C2)c1ccccc1]

(bicyclo[2.2.1]hept-5-en-2-ylmethoxy)(ethyl)(methyl)(phenyl)silane;

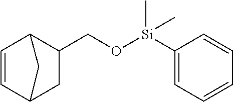 [SMILES: C[Si](C)(OCC1CC2C=CC1C2)c1ccccc1]

(bicyclo[2.2.1]hept-5-en-2-ylmethoxy)dimethyl(phenyl)silane;

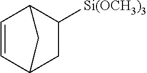

bicyclo[2.2.1]hept-5-en-2-yltrimethoxysilane;

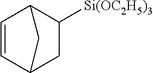

bicyclo[2.2.1]hept-5-en-2-yltriethoxysilane (TESNB, NBSi(OC₂H₅)₃);

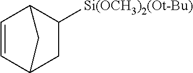

bicyclo[2.2.1]hept-5-en-2-yl(tert-butoxy)dimethoxysilane;

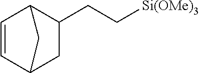

(2-(bicyclo[2.2.1]hept-5-en-2-yl)ethyl)trimethoxysilane;

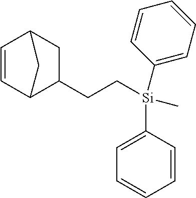 [SMILES: C[Si](CCC1CC2C=CC1C2)(c1ccccc1)c1ccccc1]

(2-(bicyclo[2.2.1]hept-5-en-2-yl)ethyl)(methyl)diphenylsilane; and

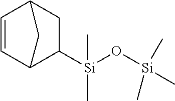

1-(bicyclo[2.2.1]hept-5-en-2-yl)-1,1,3,3,3-pentamethyldisiloxane.

Turning now to monomer of formula (VI) to form the composition of this invention it is contemplated that any monomer within the scope of monomer of formula (VI) as defined herein can be employed. Exemplary monomers of such type include but not limited to those selected from the group consisting of:

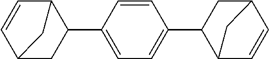 [SMILES: C1=CC2CC1CC2c1ccc(C2CC3C=CC2C3)cc1]

1,4-di(bicyclo[2.2.1]hept-5-en-2-yl)benzene;

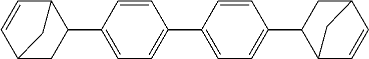 [SMILES: C1=CC2CC1CC2c1ccc(-c2ccc(C3CC4C=CC3C4)cc2)cc1]

4,4′-di(bicyclo[2.2.1]hept-5-en-2-yl)-1,1′-biphenyl;

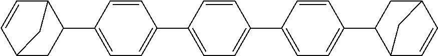 [SMILES: C1=CC2CC1CC2c1ccc(-c2ccc(-c3ccc(C4CC5C=CC4C5)cc3)cc2)cc1]

4,4″-di(bicyclo[2.2.1]hept-5-en-2-yl)-1,1′:4′,1″-terphenyl;

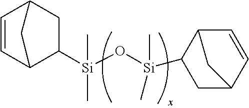

1,3-di(bicyclo[2.2.1]hept-5-en-2-yl)-1,1,3,3-tetramethyldisiloxane, when x=1 and 1,5-di(bicyclo[2.2.1]hept-5-en-2-yl)-1,1,3,3,5,5-hexamethyltrisiloxane, when x=2;

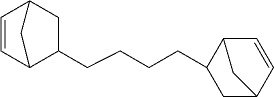 [SMILES: C1=CC2CC1CC2CCCCC1CC2C=CC1C2]

1,4-di(bicyclo[2.2.1]hept-5-en-2-yl)butane;

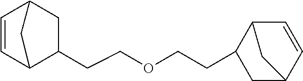 [SMILES: C1=CC2CC1CC2CCOCCC1CC2C=CC1C2]

5,5′-(oxybis(ethane-2,1-diyl))bis(bicyclo[2.2.1]hept-2-ene);

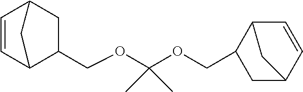 [SMILES: CC(C)(OCC1CC2C=CC1C2)OCC1CC2C=CC1C2]

5,5′-((propane-2,2-diylbis(oxy))bis(methylene))bis(bicyclo[2.2.1]hept-2-ene);

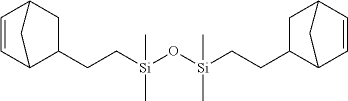 [SMILES: C[Si](C)(CCC1CC2C=CC1C2)O[Si](C)(C)CCC1CC2C=CC1C2]

1,3-bis(norbornenylethyl)-1,1,3,3-tetramethyldisiloxane (BisNBEt-Disiloxane); and

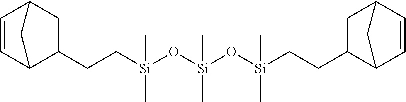 [SMILES: C[Si](C)(CCC1CC2C=CC1C2)O[Si](C)(C)O[Si](C)(C)CCC1CC2C=CC1C2]

1,5-bis(norbornenylethyl)-1,1,3,3,5,5-hexamethyltrisiloxane (BisNBEt-Trisiloxane).

In a further embodiment, the composition of this invention encompasses one or more monomers of formula (IV) and at least one monomer of formula (V).

In another embodiment, the composition of this invention encompasses one or more monomers of formula (IV) and at least one monomer of formula (V) and optionally one monomer of formula (VI).

In yet a further embodiment, the composition of this invention encompasses at least one monomer of formula (IV) and at least one monomer of formula (V), and one monomer of formula (VI).

In yet another embodiment, the composition of this invention may include one or more monomers selected from the following:

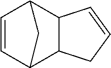

dicyclopentadiene (DCPD);

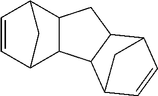 [SMILES: C1=CC2CC1C1CC3C4C=CC(C4)C3C21]

4,4a,4b,5,8,8a,9,9a-octahydro-1H-1,4:5,8-dimethanofluorene (one of trimers of cyclopentadiene, TCPD2);

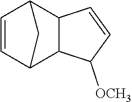 [SMILES: COC1C=CC2C3C=CC(C3)C12]

1-methoxy-dicyclopentadiene;

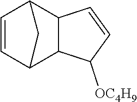

1-(n-butoxy)-dicyclopentadiene;

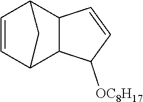

1-(n-octyloxy)-dicyclopentadiene;

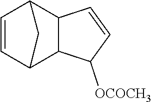

3a,4,7,7a-tetrahydro-1H-4,7-methanoinden-1-yl acetate;

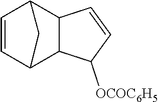

3a,4,7,7a-tetrahydro-1H-4,7-methanoinden-1-yl benzoate;

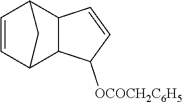

3a,4,7,7a-tetrahydro-1H-4,7-methanoinden-1-yl 2-phenylacetate; and

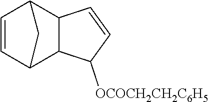

3a,4,7,7a-tetrahydro-1H-4,7-methanoinden-1-yl 3-phenylpropanoate.

In a further embodiment of this invention, the composition contains any of the palladium compounds of formula (I) that would bring about the mass polymerization as described herein. Generally, such suitable palladium compounds of formula (I) contains a bidentate monoanionic ligand A as shown, which is selected from the group consisting of:

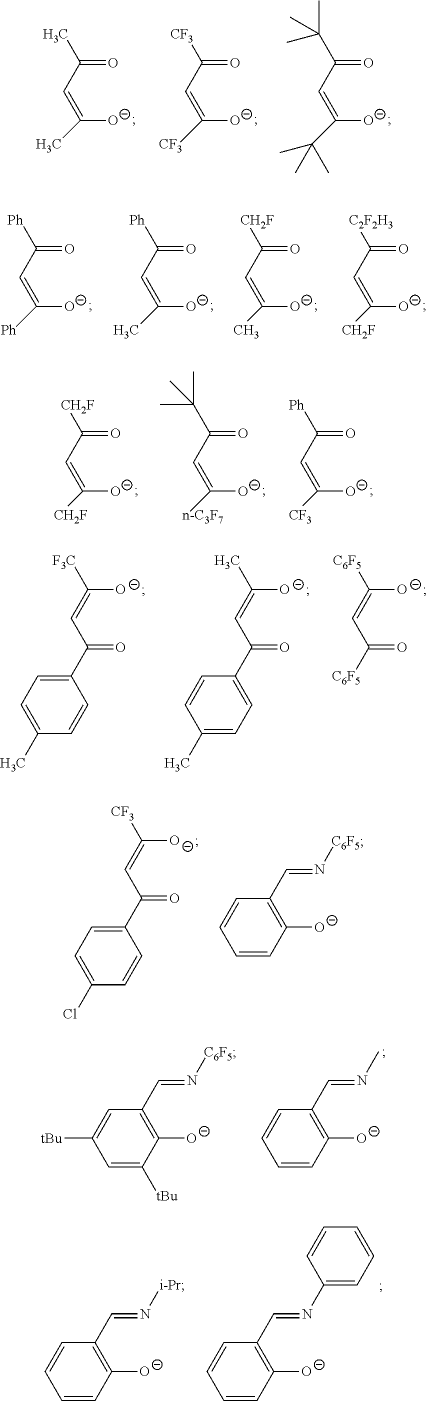

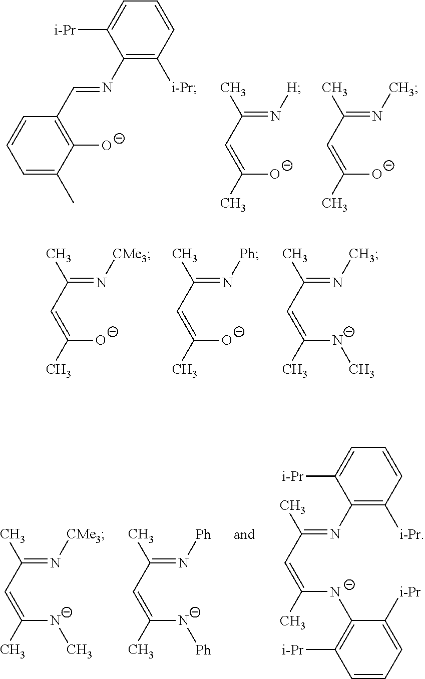

It should be understood that even though the palladium compound of formula (I) is represented by having a bidentate anionic ligand of formula A, which is further defined as above, all of such ligands can also exist in various tautomeric forms which may not appear to be bidentate anionic ligands. For example, palladium acetyl acetonate, Pd(acac)₂ can be represented by above formula of (I), it can also be represented by way of center carbon of acetylacetonate bonded to palladium as shown in Scheme 1.

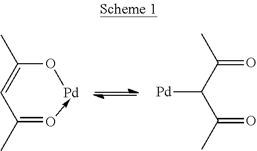

Therefore, all such isomeric forms of palladium compound of formula (I) are to be construed same as palladium compound of formula (I).

Several of the palladium compounds of formula (I) that are suitable to be employed in the compositions of this invention are known in the literature or can be readily made by any of the known procedures in the art. See for example, Bull. Chem. Soc. Japan, 1974, 47, 665-668.

Exemplary palladium compounds of formula (I) that can be employed in the composition of this invention without any limitation include the following:

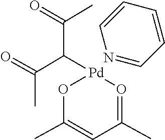

palladium bis(acetylacetonate)pyridine (Pd384);

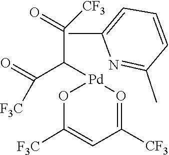

palladium bis(hexafluoroacetylacetonate)-2,6-dimethylpyridine (Pd628);

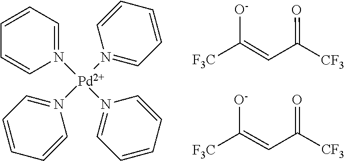

palladium bis(hexafluoroacetylacetonate)tetrapyridine (Pd837);

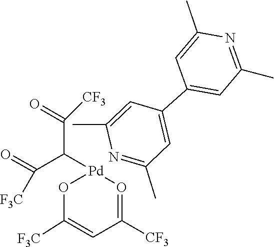

palladium bis(hexafluoroacetylacetonate)-2,2′,6,6′-tetramethyl-4,4′-bipyridine (Pd733);

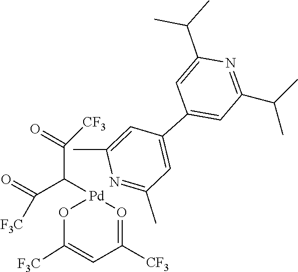

palladium bis(hexafluoroacetylacetonate)-2,6-dimethyl-2′,6′-diisopropyl-4,4′-bipyridine (Pd788);

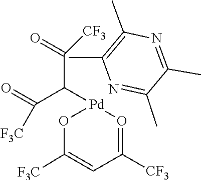

palladium bis(hexafluoroacetylacetonate)-2,3,5,6-tetramethylpyrazine (Pd657);

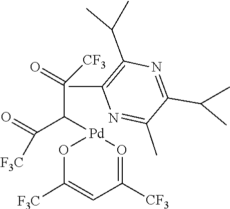

palladium bis(hexafluoroacetylacetonate)-2,3-dimethyl-5,6-diisopropylpyrazine (Pd712);

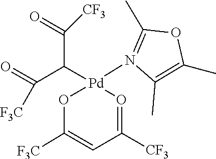

palladium bis(hexafluoroacetylacetonate)-2,4,5-trimethyloxazole (Pd631); and

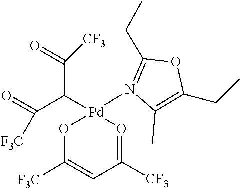

palladium bis(hexafluoroacetylacetonate)-4-methyl-2,5-diethyloxazole (Pd656).

As noted, the composition of this invention further contains a soluble photoacid generator which when combined with the palladium compound of formula (I) and a photosensitizer will cause mass polymerization of the monomers contained therein when exposed to suitable radiation as described hereinbelow. Any of the known photoacid generators can be used in the compositions of this invention, which would being about this effect, such as for example, certain of the halonium salts, sulfonium salts, and the like.

In some embodiments the soluble photoacid generator of formula (IIA) is employed in the composition of this invention:

Aryl₁-Hal^{⊕}-Aryl₂An^{⊖} (IIA)

Wherein Aryl₁ and Aryl₂ are the same or different and are independently selected from the group consisting of substituted or unsubstituted phenyl, biphenyl and naphthyl; Hal is iodine or bromine; and An^{⊖} is a weakly coordinating anion (WCA) which is weakly coordinated to the cation complex. More specifically, the WCA anion functions as a stabilizing anion to the cation complex. The WCA anion is relatively inert in that it is non-oxidative, non-reducing, and non-nucleophilic. In general, the WCA can be selected from borates, phosphates, arsenates, antimonates, aluminates, boratobenzene anions, carborane, halocarborane anions, sulfonamidate and sulfonates

Representative examples of the compounds of formula (IIA) may be listed as follows:

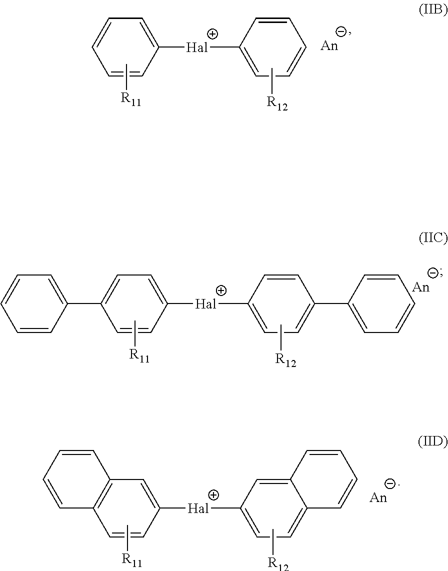

Wherein R₁₁ and R₁₂ are as defined herein. Similarly various sulfonium salts can be used as photoacid generators, which include broadly compounds of formula (II) as described herein.

Accordingly, non-limiting examples of suitable photoacid generators of formulae (II) or (III) that may be employed in the composition of this invention are listed below:

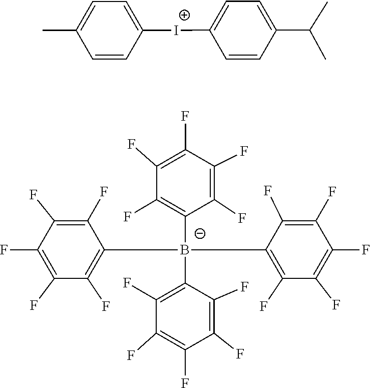 [SMILES: Cc1ccc([I+]c2ccc(C(C)C)cc2)cc1 ; Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F]

tolylcumyliodonium-tetrakis pentafluorophenylborate, commercially available under the tradename Rhodorsil 2074© from Bluestar Silicones;

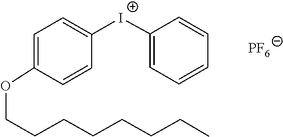 [SMILES: CCCCCCCCOc1ccc([I+]c2ccccc2)cc1 ; "PF6"]

4-(octyloxy)phenyl)(phenyl)iodonium hexafluorophosphate (OPPI—PF₆);

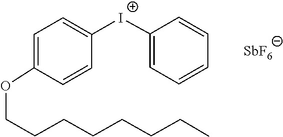

4-(octyloxy)phenyl)(phenyl)iodonium hexafluoroantimonate (OPPI—SBF₆);

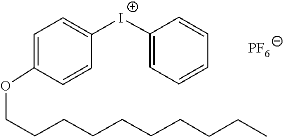 [SMILES: CCCCCCCCCCOc1ccc([I+]c2ccccc2)cc1 ; "PF6"]

4-(decyloxy)phenyl)(phenyl)iodonium hexafluorophosphate (DPPI-PF₆);

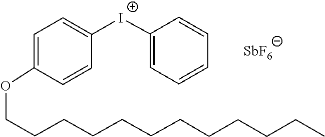

4-(dodecyloxy)phenyl)(phenyl)iodonium hexafluoroantimonate (DoPPI-SBF₆);

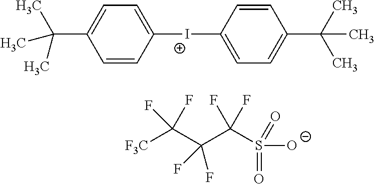 [SMILES: CC(C)(C)c1ccc([I+]c2ccc(C(C)(C)C)cc2)cc1 ; O=S(=O)([O-])C(F)(F)C(F)(F)C(F)(F)C(F)(F)F]

bis(4-tert-butylphenyl)iodonium perfluoro-1-butanesulfonate;

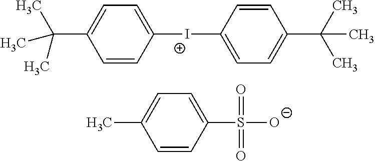

bis(4-tert-butylphenyl)iodonium p-toluenesulfonate;

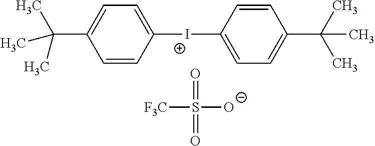 [SMILES: CC(C)(C)c1ccc([I+]c2ccc(C(C)(C)C)cc2)cc1 ; O=S(=O)([O-])C(F)(F)F]

bis(4-tert-butylphenyl)iodonium triflate;

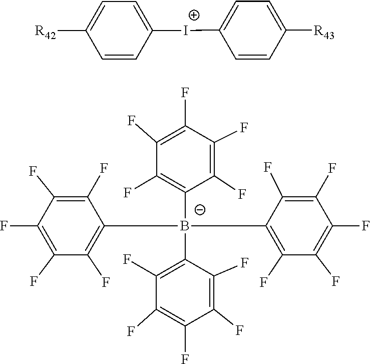

where R₄₂ and R₄₃ are the same or different and each independently selected from linear or branched (C₁₀-C₁₃)alkyl, for example, 4,4′-di-(C₁₀-C₁₃)alkylphenyl-iodonium tetrakis(2,3,4,5,6-pentafluorophenyl)borate is commercially available under the tradename SILCOLEASE UV CATA 243 (PAG1);

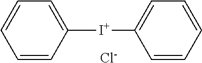 [SMILES: c1ccc([I+]c2ccccc2)cc1 ; [Cl-]]

diphenyliodonium chloride;

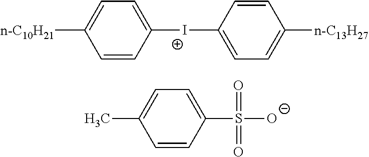

n-decylphenyl-n-tridecylphenyliodoniump-toluenesulfonate;

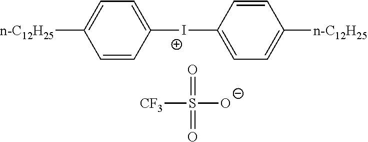

bis(n-dodecylphenyl)iodonium triflate;

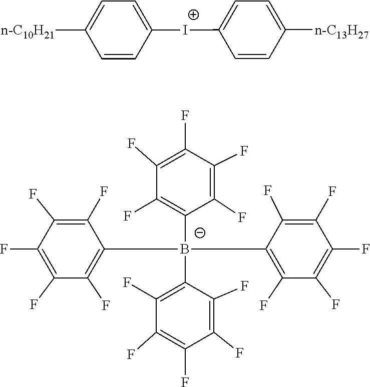

4-n-decylphenyl-4′-n-tridecylphenyliodonium tetrakis(pentafluorophenyl)borate;

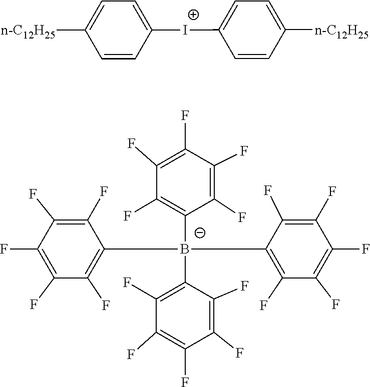

di(4-n-dodecylphenyl)iodonium tetrakis(pentafluorophenyl)borate;

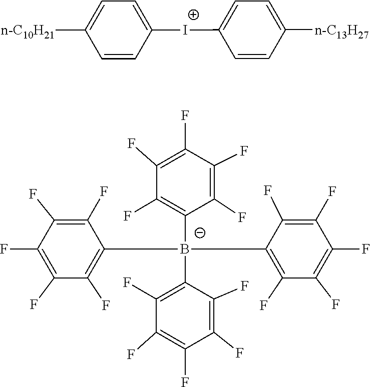

4-n-decylphenyl-4′-n-tridecylphenyliodonium tetrakis(pentafluorophenyl)borate;

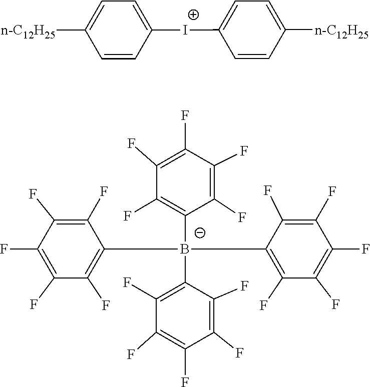

di(4-n-dodecylphenyl)iodonium tetrakis(pentafluorophenyl)borate;

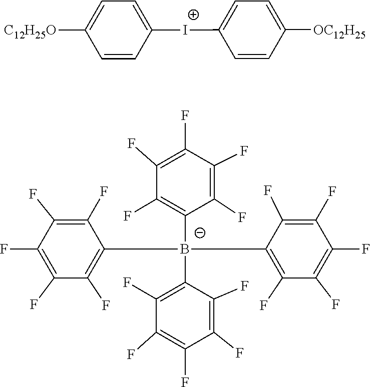

di(4-n-dodecyloxyphenyl)iodonium tetrakis(pentafluorophenyl)borate;

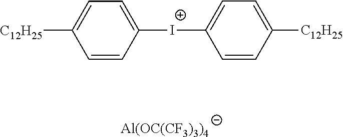

bis(4-dodecylphenyl)iodonium tetrakis((1,1,1,3,3,3-hexafluoro-2-(trifluoromethyl)propan-2-yl)oxy)aluminate;

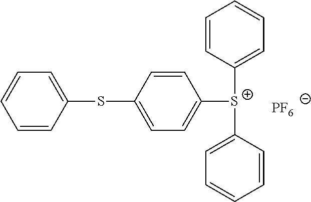

(4-thiophenyl)phenyl-diphenylsulfonium hexafluorophosphate;

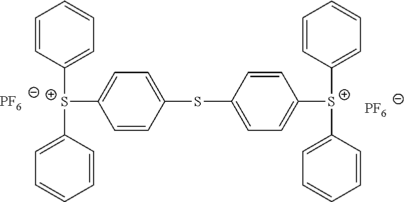

bis-(triphenylsulfonium) sulfide bis-hexafluorophosphate;

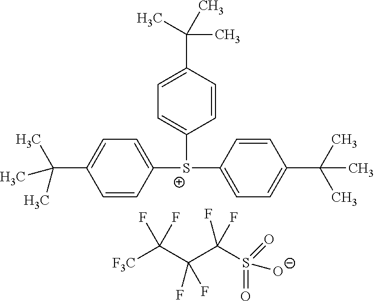 [SMILES: CC(C)(C)c1ccc([S+](c2ccc(C(C)(C)C)cc2)c2ccc(C(C)(C)C)cc2)cc1 ; O=S(=O)([O-])C(F)(F)C(F)(F)C(F)(F)C(F)(F)F]

tris(4-tert-butylphenyl)sulfonium perfluoro-1-butanesulfonate;

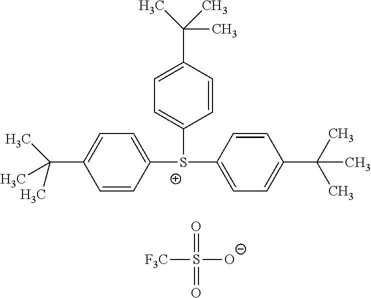 [SMILES: CC(C)(C)c1ccc([S+](c2ccc(C(C)(C)C)cc2)c2ccc(C(C)(C)C)cc2)cc1 ; O=S(=O)([O-])C(F)(F)F]

tris(4-tert-butylphenyl)sulfonium triflate;

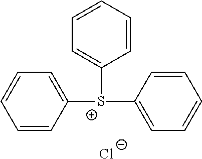 [SMILES: c1ccc([S+](c2ccccc2)c2ccccc2)cc1 ; [Cl-]]

triphenylsulfonium chloride;

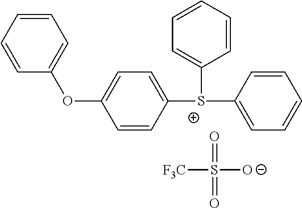 [SMILES: c1ccc(Oc2ccc([S+](c3ccccc3)c3ccccc3)cc2)cc1 ; O=S(=O)([O-])C(F)(F)F]

(4-phenoxyphenyl)diphenylsulfonium triflate;

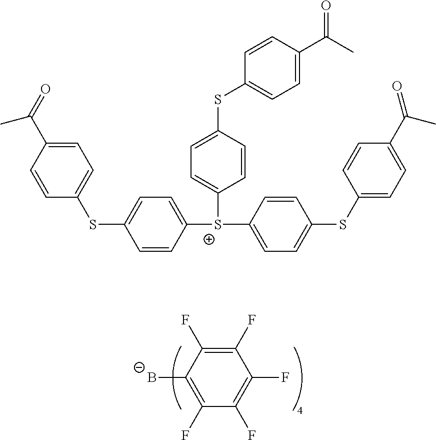

tris(4-((4-acetylphenyl)thio)phenyl)sulfonium tetrakis-pentafluorophenylborate (Irgacure PAG 290);

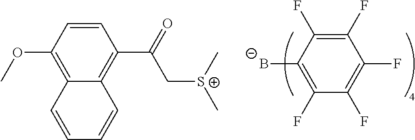

(2-(4-methoxynaphthalen-1-yl)-2-oxoethyl)dimethylsulfonium tetrakis-pentafluorophenylborate (TAG 382);

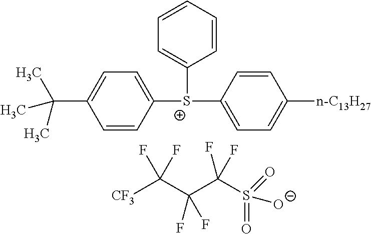

(4-tert-butylphenyl)(phenyl)(4′-tridecylphenyl)sulfonium perfluoro-1-butanesulfonate; and

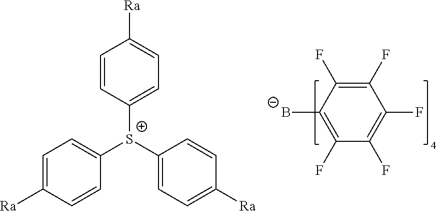

tri(4-alkylphenyl)sulfonium tetrafluoroborates, where each Rₐ is independently selected from linear or branched (C₁₀-C₁₃)alkyl, are commercially available under the tradename CPI® 300 or 400 series from San-Apro Ltd.

However, any of the other known photoacid generators which can activate the palladium compound of formula (I) as employed herein when exposed to suitable radiation can also be used in the composition of this invention. All such compounds are part of this invention.

As noted, the composition of this invention additionally contains a photosensitizer compound which further facilitates the formation of the active catalyst when the composition is exposed to suitable radiation in the presence of the photoacid generator as employed herein. For this purpose, any suitable sensitizer compound can be employed in the compositions of the present invention, which activates the photoacid generator and/or the palladium compound of formula (I). Such suitable sensitizer compounds include, anthracenes, phenanthrenes, chrysenes, benzpyrenes, fluoranthenes, rubrenes, pyrenes, xanthones, indanthrenes, thioxanthen-9-ones, and mixtures thereof. In some exemplary embodiments, suitable sensitizer components include a compound of formula (VII) or a compound of formula (VIII):

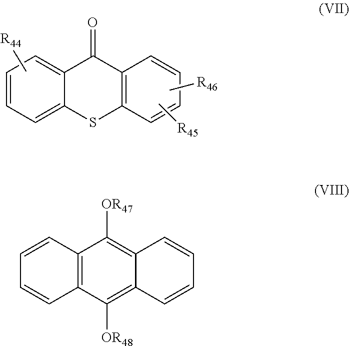

wherein
R₄₄, R₄₅ and R₄₆ are the same or different and independently of each other selected from the group consisting of hydrogen, halogen, hydroxy, NO₂, NH₂, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl, (C₆-C₁₀)-aryloxy, C(O)(C₁-C₆)alkyl, COOH, C(O)O(C₁-C₆)alkyl, and SO₂(C₆-C₁₀)aryl;
R₄₇ and R₄₈ are the same or different and independently of each other selected from the group consisting of methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl and (C₆-C₁₀)aryl(C₁-C₃)alkyl.

Representative examples of the compounds of formula (VII) or the compounds of formula (VIII) without any limitation may be listed as follows:

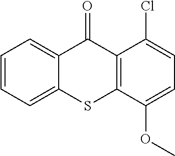 [SMILES: COc1ccc(Cl)c2c(=O)c3ccccc3sc12]

1-chloro-4-methoxy-9H-thioxanthen-9-one;

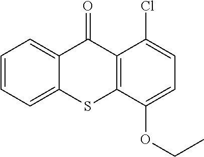 [SMILES: CCOc1ccc(Cl)c2c(=O)c3ccccc3sc12]

1-chloro-4-ethoxy-9H-thioxanthen-9-one;

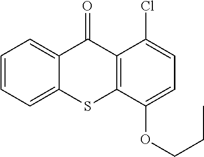 [SMILES: CCCOc1ccc(Cl)c2c(=O)c3ccccc3sc12]

1-chloro-4-propoxy-9H-thioxanthen-9-one (commercially sold under the name CPTX from Lambson);

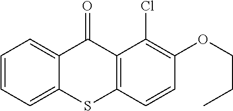 [SMILES: CCCOc1ccc2sc3ccccc3c(=O)c2c1Cl]

1-chloro-2-propoxy-9H-thioxanthen-9-one;

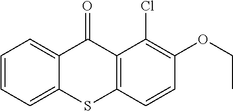 [SMILES: CCOc1ccc2sc3ccccc3c(=O)c2c1Cl]

1-chloro-2-ethoxy-9H-thioxanthen-9-one;

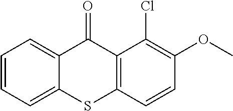 [SMILES: COc1ccc2sc3ccccc3c(=O)c2c1Cl]

1-chloro-2-methoxy-9H-thioxanthen-9-one;

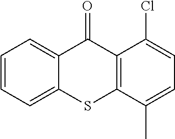 [SMILES: Cc1ccc(Cl)c2c(=O)c3ccccc3sc12]

1-chloro-4-methyl-9H-thioxanthen-9-one;

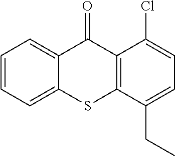 [SMILES: CCc1ccc(Cl)c2c(=O)c3ccccc3sc12]

1-chloro-4-ethyl-9H-thioxanthen-9-one;

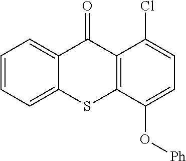 [SMILES: O=c1c2ccccc2sc2c(Oc3ccccc3)ccc(Cl)c12]

1-chloro-4-phenoxy-9H-thioxanthen-9-one;

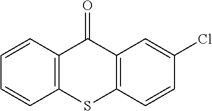 [SMILES: O=c1c2ccccc2sc2ccc(Cl)cc12]

2-chlorothioxanthen-9-one (CTX);

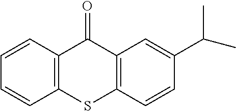 [SMILES: CC(C)c1ccc2sc3ccccc3c(=O)c2c1]

2-isopropyl-9H-thioxanthen-9-one (ITX);

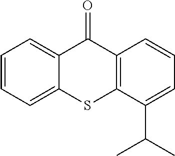 [SMILES: CC(C)c1cccc2c(=O)c3ccccc3sc12]

4-isopropyl-9H-thioxanthen-9-one;

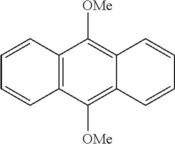 [SMILES: COc1c2ccccc2c(OC)c2ccccc12]

9,10-dimethoxyanthracene (DMA);

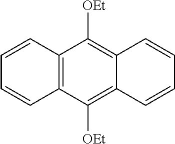 [SMILES: CCOc1c2ccccc2c(OCC)c2ccccc12]

9,10-diethoxyanthracene (DEA); and

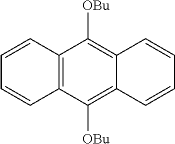

9,10-diethoxyanthracene (DBA).

Other suitable photosensitizer compounds include various substituted and unsubstituted phenothiazine derivatives, such as for example:

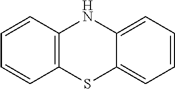 [SMILES: c1ccc2c(c1)Nc1ccccc1S2]

phenothiazine.

Generally, photosensitizers absorb energy from the radiated light source and transfers that energy to the desirable substrate/reactant, which in the present invention is the photoacid generator employed in the composition of this invention. In some embodiments the compounds of formula (VII) or the compounds of formula (VIII) can be activated at certain wavelength of the electromagnetic radiation which can generally range from about 240 nm to 410 nm. Accordingly, any of the compounds which are active in this electromagnetic radiation can be employed in the compositions of this invention which are stable to various fabrications methods where the compositions of this invention can be used including for example OLED or the 3D fabrication methods. In some embodiments the wavelength of the radiation to activate the compounds of formulae (VII) or (VIII) is 260 nm. In some other embodiments the wavelength of the radiation to activate the compounds of formula (VII) or (VIII) is 310 nm. In some other embodiments the wavelength of the radiation to activate the compounds of formula (VII) or (VIII) is 365 nm. In yet some other embodiments the wavelength of the radiation to activate the compounds of formula (VII) or (VIII) is 395 nm.

Any amount of palladium compound of formula (I), the photoacid generator of formulae (II) or (III) and the photosensitizer of formulae (VII) or (VIII) can be employed in the composition of this invention which will bring about the intended result. Generally, the molar ratio of monomer of formula (IV):compound of formula (I) is in the range of 25,000:1 to 5,000:1 or lower. In some other embodiments such monomer of formula (IV):compound of formula (I) is 10,000:1, 15,000:1, 20,000:1 or higher than 30,000:1. It should be noted that monomer of formula (IV) as mentioned herein may include one or more monomers of formula (IV) distinct from each other and may additionally contain one or more monomers of formulae (V) or (VI), and therefore, the above ratio represents combined molar amounts of all such monomers employed. Similarly, the molar ratio of palladium compound of formulae (I):the photoacid generator of formulae (II) or (III):the photosensitizer of formulae (VII) or (VIII) is in the range of 1:1:1 to 1:35:3 or 1:10:1 or 1:9:2, 1:4:2, 1:9:3, 1:35:2 or such ranges which will bring about the intended benefit.

Advantageously, it has further been found that the composition according to this invention forms a substantially transparent film when exposed to a suitable actinic radiation (UV irradiation). That is to say that when the composition of this invention is exposed to certain actinic radiation, the monomers undergo mass polymerization to form films which are substantially transparent to visible light. That is, most of the visible light is transmitted through the film. In some embodiments such film formed from the composition of this invention exhibits a transmission of equal to or higher than 90 percent of the visible light. In some other embodiments such film formed from the composition of this invention exhibits a transmission of equal to or higher than 95 percent of the visible light. It should be further noted that any actinic radiation that is suitable to carry out this mass polymerization can be employed, such as for example, exposure to any actinic radiation in the wavelength of 200 nm to 400 nm. However, any radiation higher than 400 nm can also be employed. In some embodiments the wavelength of the actinic radiation employed is 250 nm, 295 nm, 360 nm, 395 nm or higher than 400 nm.

In some other embodiments the composition of this invention undergoes mass polymerization when exposed to suitable actinic radiation and heat to form a substantially transparent film. In yet other embodiments the composition of this invention undergoes mass polymerization when exposed to suitable UV irradiation at a temperature from 50° C. to 100° C. to form a substantially transparent film.

Accordingly, exemplary compositions of this invention without any limitation may be enumerated as follows:
5-phenethylbicyclo[2.2.1]hept-2-ene (PENB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(hexafluoroacetylacetonate)-tetrapyridine (Pd837), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,6-dimethylpyridine (Pd628), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,3,5,6-tetramethylpyrazine (Pd657), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-hexylbicyclo[2.2.1]hept-2-ene (HexylNB), palladium bis(hexafluoroacetylacetonate)-2,2′,6,6′-tetramethyl-4,4′-bipyridine (Pd733), di(4-n-dodecylphenyl)iodonium tetrakis(pentafluorophenyl)borate and 2-isopropyl-9H-thioxanthen-9-one (ITX); and
5-decylbicyclo[2.2.1]hept-2-ene (DecNB), palladium bis(hexafluoroacetylacetonate)-2,4,5-trimethyloxazole (Pd631), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX).

In a further aspect of this invention there is provided a kit for forming a substantially transparent film. There is dispensed in this kit a composition of this invention. Accordingly, in some embodiments there is provided a kit in which there is dispensed one or more olefinic monomers of formula (IV) as described herein; a palladium compound of formula (I) as described herein; a photoacid generator of formulae (II) or (III) as described herein and a photosensitizer of formulae (VII) or (VIII). In some embodiments the kit of this invention contains one or more monomers of formula (IV) optionally in combination with one or more monomers of formulae (V) or (VI) so as to obtain a desirable result and/or for an intended purpose.

In some embodiments, the aforementioned kit encompasses one or more monomers of formula (IV) and one or more monomers of formulae (V) or (VI). In some other embodiments the kit of this invention encompasses at least two monomers wherein first monomer serves as a solvent for the second monomer. Any of the monomers of formulae (IV), (V) or (VI) as described herein can be used in this embodiment. The molar ratio of such two monomers contained in these embodiments can vary and may range from 1:99 to 99:1, or 10:90 to 90:10, 20:80 to 80:20, 30:70 to 70:30, 60:40 to 40:60 or 50:50, and so on. In some other embodiments the kit may encompass a composition wherein dispensed two monomers which could be one monomer of formula (IV) and another monomer of formula (V). Further, the monomer of formula (V) and the photoacid generator are completely soluble in monomer of formula (IV) to form a clear solution at room temperature (˜25° C.). In some embodiments the monomer mixture may become a clear solution at slightly elevated temperature, such as for example, 30° C. or 40° C. or 50° C., before they undergo mass polymerization.

In another aspect of this embodiment of this invention the composition contained in the kit of this invention undergoes mass polymerization when exposed to suitable actinic radiation for a sufficient length of time to form a polymeric film. That is to say that the composition of this invention is poured onto a surface or onto a substrate which needs to be encapsulated and exposed to suitable radiation in order for the monomers to undergo polymerization to form a solid transparent polymer which could be in the form of a transparent film. Generally, as already noted above, such polymerization can take place at various wavelengths of actinic radiation, such as for example, at 265 nm 315 nm 365 nm or 395 nm and so on. The mass polymerization may further be accelerated by heating, which can also be in stages, for example heating to 40° C. or 50° C. or 60° C. for 5 minutes each, and if necessary further heating to 70° C. for various lengths of time such as from 5 minutes to 15 minutes and so on. By practice of this invention, it is now possible to obtain polymeric films on such substrates which are substantially transparent film. The “substantially transparent film” as used herein means that the films formed from the composition of this invention are optically clear in the visible light. Accordingly, in some embodiments of this invention such films are having at least 90 percent of visible light transmission, in some other embodiments the films formed from the composition of this invention exhibit at least 95 percent of visible light transmission.

In some embodiments of this invention the kit as described herein encompasses a composition which further contains one or more monomers selected from a monomer of formula (V) or a monomer of formula (VI) as described hereinabove. Again, any of the monomers of formula (V) or (VI) as described herein can be used in this embodiment, and in any desirable amounts depending on the nature of the intended use.

In some embodiments, the kit as described herein encompasses various exemplary compositions as described hereinabove.

In yet another aspect of this invention there is further provided a method for forming a substantially transparent film for the fabrication of a variety of optoelectronic device comprising: forming a homogeneous clear composition comprising one or more monomers of formula (IV); a palladium compound of formula (I); a photoacid generator of formulae (II) or (III); and a photosensitizer of formulae (VII) or (VIII);
coating a suitable substrate with the composition or pouring the composition onto a suitable substrate to form a film; and
exposing the film to a suitable actinic radiation to cause polymerization of the monomers.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. The mixture can also be poured onto a substrate to form a film. Suitable substrate includes any appropriate substrate as is, or may be used for electrical, electronic or optoelectronic devices, for example, a semiconductor substrate, a ceramic substrate, a glass substrate.

Next, the coated substrate is exposed to suitable radiation as described herein. Alternatively, the coated substrate is baked, i.e., heated to facilitate the mass polymerization, for example to a temperature from 50° C. to 100° C. for about 1 to 60 minutes, although other appropriate temperatures and times can be used. In some embodiments the substrate is baked at a temperature of from about 60° C. to about 90° C. for 2 minutes to 10 minutes. In some other embodiments the substrate is baked at a temperature of from about 60° C. to about 90° C. for 5 minutes to 20 minutes.

The films thus formed are then evaluated for their optical properties using any of the methods known in the art. For example, the refractive index of the film across the visible spectrum can be measured by ellipsometry. The optical quality of the film can be determined by visual observation. Quantitatively the percent transparency can be measured by visible spectroscopy. Generally, the films formed according to this invention exhibit excellent optical transparent properties and can be tailored to desirable refractive index as described herein.

Accordingly, in some of the embodiments of this invention there is also provided an optically transparent film obtained by the mass polymerization of the composition as described herein. In another embodiment there is also provided an optoelectronic device comprising the transparent film of this invention as described herein.

In yet some other embodiments the composition of this invention can also be used in a variety of photo induced nanoimprint lithography (NIL), such as for example, UV-NIL. For instance, the compositions of this invention can be used in a variety of photocurable imprint technology. Typically, in such applications, the composition of this invention is suitably placed on a substrate (for example by coating or similar means), which is then covered by a suitable stamp and exposed to radiation so as to allow the composition of this invention to cure to a solid. The stamp is then released to obtain the nano-imprinted film. Such substrates can include for example a master digital video disk (DVD).

The following examples are detailed descriptions of methods of preparation and use of certain compounds/monomers, polymers and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### Examples

The following abbreviations have been used hereinbefore and hereafter in describing some of the compounds, instruments and/or methods employed to illustrate certain of the embodiments of this invention:
PENB-5-phenethylbicyclo[2.2.1]hept-2-ene; DecNB-5-phenethylbicyclo[2.2.1]hept-2-ene; CHEpNB-3-(bicyclo[2.2.1]hept-5-en-2-yl)-7-oxabicyclo[4.1.0]heptane; Pd304-palladium bis(acetylacetonate) (Pd(acac)₂); Pd520-palladium bis(hexafluoroacetylacetonate); Pd384-palladium bis(acetylacetonate)pyridine; Pd628-palladium bis(hexafluoroacetylacetonate)-2,6-dimethylpyridine; Pd631-palladium bis(hexafluoroacetylacetonate)-2,4,5-trimethyloxazole; Pd657-palladium bis(hexafluoroacetylacetonate)-2,3,5,6-tetramethylpyrazine; Pd733-palladium bis(hexafluoroacetylacetonate)-2,2′,6,6′-tetramethyl-4,4′-bipyridine; Pd837-palladium bis(hexafluoroacetylacetonate)tetrapyridine; Pd680-palladium (hexafluoroacetylacetonate)₂ tri-isopropylphosphine; PAG1-4,4′-di-(C₁₀-C₁₃)alkylphenyl-iodonium tetrakis(2,3,4,5,6-pentafluorophenyl)borate; ITX-4-isopropylthioxanthone; HALS-bis(1-octyloxy-2,2,6,6-tetramethylpiperidin-4-yl) sebacate; THF—tetrahydrofuran; cP—centipoise; DSC—differential scanning calorimetry.

Various monomers as used herein are either commercially available or can be readily prepared following the procedures as described in U.S. Pat. No. 9,944,818.

Various palladium compounds of formula (I) as used herein are either known in the literature and are available commercially or can be readily prepared following the procedures as described herein.

### Example 1

Palladium bis(acetylacetonate)pyridine (Pd384)

The title compound is prepared in accordance with the procedures as set out in Bull. Chem. Soc. Japan, 1974, 47, 665-668.

Pd304 (0.29 g, 0.57 mmol) was placed to a 50 mL round bottom flask. To which was added pyridine (5 mL). The reaction mixture was heated to 80° C. for 15 minutes and then petroleum ether was added to precipitate the product. The product was collected and washed with petroleum ether to obtain Pd384 (180 mg, 49% yield). The NMR spectroscopy of the resulting material matched previously published data for this compound.

### Example 2

Palladium bis(hexafluoroacetylacetonate)-2,6-dimethylpyridine (Pd628)

Pd520 (0.2 g, 0.384 mmol) was placed in a 50 mL Schlenk flask equipped with a magnetic stir bar. The flask was purged with nitrogen and then closed with a rubber septum. Anhydrous pentane (5 mL) was added to the tube and the mixture was stirred until Pd520 dissolved (˜5-10 min) to give a light-yellow orange solution. To this solution was added 2,6-dimethylpyridine (0.133 g, 1.29 mmol). The solution was stirred overnight (˜17 h). The resulting yellow precipitate was collected and washed with cold hexanes (˜0-5° C.). The yellow precipitate was recrystallized from hexanes to give 0.105 g (44%) yellow needles of Pd628. The NMR spectroscopy of the resulting material matched previously published data for this compound.

### Example 3

Palladium bis(hexafluoroacetylacetonate)-2,4,5-trimethyloxazole (Pd631)

Pd520 (0.198 g, 0.381 mmol) was placed in a 50 mL Schlenk flask. The flask was purged with nitrogen. Anhydrous hexanes (5 mL) was added to the flask and the mixture was stirred till Pd520 completely dissolved. 2,4,5-trimethyloxazole (0.0688 g, 0.619 mmol) was added to the reaction mixture. The reaction mixture was stirred overnight, a precipitate formed during this stirring period. The precipitate was collected and dissolved in petroleum ether. The solution was cooled to 0° C. The resulting crystals were collected and washed with cold petroleum ether to obtain Pd631 (51.5 mg, 21% yield). ¹H NMR (500 MHz, C₆D6): 5.95 (s, 1H), 5.22 (s, 1H), 2.19 (s, 3H), 1.91 (s, 3H), 1.19 (s, 3H). ¹⁹F NMR (470 MHz, C₆D6): −76.68 (s, 3F), −76.59 (s, 3F), −74.28 (bs, 6F).

### Example 4

Palladium bis(hexafluoroacetylacetonate)-2,3,5,6-tetramethylpyrazine (Pd657)

A mixture of Pd520 (0.2 g, 0.384 mmol) and 2,3,5,6-tetramethylpyrazine (0.0557 g) was placed in a 50 mL round bottom flask purged with nitrogen and then added hexanes (5 mL). The reaction mixture was then heated to 60° C. and maintained at that temperature overnight (˜17 h). The reaction mixture was then cooled to room temperature. The resulting precipitate was collected and washed with hexanes to obtain Pd657 (124 mg, 49% yield). ¹H NMR (500 MHz, CDCl₃): 6.31 (s, 1H), 4.99 (s, 1H), 3.23 (s, 3H), 2.56 (s, 3H). ¹⁹F NMR (470 MHz, CDCl₃): −76.75 (s, 6F), −74.38 (s, 3F), −74.28 (s, 3F).

### Example 5

Palladium bis(hexafluoroacetylacetonate)-2,2′,6,6′-tetramethyl-4,4′-bipyridine (Pd733)

Pd520 (0.205 g, 0.394 mmol) was placed in a 50 mL Schlenk flask purged with nitrogen. To this was added anhydrous hexanes (5 mL). The mixture stirred until it completely dissolved. To this solution was added 2,2′,6,6′-tetramethyl-4,4′-bipyridine (89.5 mg, 0.422 mmol, prepared in accordance with the procedure set out in J. Am. Chem. 2022, 8, 3653-3659). The mixture was stirred for 2 days. Additional hexanes (5 mL) was added to the solution then heated to 70° C. for 12 h. After the heating period, the reaction mixture was cooled to room temperature. A precipitate formed during the cooling. The precipitate was collected and washed with hexanes to obtain Pd733 (96 mg, 34% yield). ¹H NMR (500 MHz, C₆D6): 6.47 (s, 2H), 6.41 (s, 2H), 6.03 (s, 1H), 5.28 (s, 1H), 2.91 (s, 3H), 2.48 (s, 3H). ¹⁹F NMR (470 MHz, C₆D6): −76.62 (s, 6F), −74.17 (s, 3F), −74.10 (s, 3F).

### Example 6

Palladium bis(hexafluoroacetylacetonate)tetrapyridine (Pd837)

Pd520 (0.29 g, 0.57 mmol) was placed in a 50 mL round bottom flask. To this was added pyridine (5 mL). The reaction mixture was heated to 80° C. for 1.5 h and then cooled to room temperature. A white precipitate formed during the heating period. This precipitate was collected and washed with petroleum ether. The precipitate was dissolved in dichloromethane and then petroleum ether was added to until a precipitate was formed. The mixture was stirred for one hour and then the precipitate was collected, 0.21 g (44% yield) of Pd837 was obtained. The NMR spectroscopy of the resulting material matched previously published data for this compound.

### Example 7

### Shelf-Life Stability of Various Compositions

In a glass bottle, palladium compound of formula (I), ITX, PAG1 and various monomers as listed in Table 1 were rolled until a clear solution formed. Also listed in Table 1 is the molar parts of each of the components used in the respective compositions. Each of these compositions was exposed to 4 J/cm² at 395 nm and the enthalpy released over 5 minutes (J/g) was measured by UV-DSC. The samples were stored at various temperatures as summarized in Table 1 and the compositions were monitored for gelation over time. It is apparent from these studies that the composition of this invention has a longer shelf life than the compositions reported in the art.

TABLE 1

| | | | | | Temperature | Days |
|---|---|---|---|---|---|---|
| Pd | | Pd:Monomer | | Enthalpy | for shelf-Life | to |
| Compound | Monomer | (Molar Ratio) | Pd:ITX:PAG1 | Change | Study (° C.) | Gel |
| Pd384 | PENB | 10,000:1 | 1:3:9 | 298 | 40 | 4 |
| Pd304 | PENB | 10,000:1 | 1:3:9 | 237 | 40 | 1 |
| (prior art) | | | | | | |
| Pd837 | PENB:CHEpNB | 10,000:1 | 1:2:35 | 242 | 60 | 7 |
| | 80:20 | | | | | |
| Pd520 | PENB:CHEpNB | 10,000:1 | 1:2:35 | 259 | 60 | <1 |
| (prior art) | 80:20 | | | | | hour |
| Pd628 | DecNB | 5,000:1 | 1:2:35 | 314 | 60 | 6 |
| Pd520 | DecNB | 5,000:1 | 1:2:35 | 282 | 60 | 1 |
| (prior art) | | | | | | |
| Pd657 | DecNB | 10,000:1 | 1:3:9 | 264 | 25 (room | >300 |
| | | | | | temperature) | |
| Pd520 | DecNB | 10,000:1 | 1:3:9 | 279 | 25 (room | 2 |
| | | | | | temperature) | |

### Example 8

### DSC-UV Studies Over Time

The procedures of Example 7 were substantially followed in this Example 8 to form a composition containing various palladium compounds of this invention with DecNB, ITX and PAG1 as summarized in Table 2 and were stored at room temperature (˜25° C.). Each of the compositions was exposed to UV light for 4 sec (4 J/cm², 395 nm) and enthalpy released over five minutes was measured by UV-DSC measurements over a period of time and the results are summarized in Table 2. It is again evident that the composition containing Pd520 of the prior art gelled within four days whereas the compositions of this invention were stable even after 20 days of storage and retained the activity as evidenced by insignificant change in enthalpy over the measured period of time.

TABLE 2

| | Initial | Enthalpy | Enthalpy | Enthalpy | Enthalpy |
|---|---|---|---|---|---|
| Pd | Enthalpy | after 4 | after 8 | after 12 | after 20 |
| Compound | (J/g) | days (J/g) | days (J/g) | days (J/g) | days (J/g) |
| Pd520 | 221 | Gelled | | | |
| (prior art) | | | | | |
| Pd628 | 148 | 190 | 183 | 173 | 155 |
| Pd657 | 220 | 201 | 224 | 203 | 179 |

Pd compound:DecNB—1:10,000 molar ratio;
Pd compound:ITX:PAG1—1:2:4 molar ratio

### Example 9

### Viscosity Studies Over Time

The procedures of Example 8 were substantially followed in this Example 9 to form a composition containing various palladium compounds of this invention with DecNB, ITX and PAG1 as summarized in Table 3. The viscosity of each of these compositions was measured over a period of time and the results are summarized in Table 3. It is again evident that the composition containing Pd520 of the prior art gelled within four days whereas the compositions of this invention were stable even after 20 days of storage and exhibited little change in viscosity and did not gel during the course of this study.

TABLE 3

| | Viscosity | Viscosity | Viscosity | Viscosity | Viscosity |
|---|---|---|---|---|---|
| Pd | Initial | after 4 | after 8 | after 12 | after 20 |
| Compound | (cP) | days (cP) | days (cP) | days (cP) | days (cP) |
| Pd520 | 7.3 | Gelled | | | |
| (prior art) | | | | | |
| Pd628 | 7.6 | 7.6 | 7.7 | 7.9 | 8 |
| Pd657 | 7.2 | 8.3 | 9.8 | 11.5 | 13 |

Pd compound:DecNB—1:10,000 molar ratio;
Pd compound:ITX:PAG1—1:2:4 molar ratio

### Example 10

### Thin Film Formation in Air

In a glass bottle, Pd657 (one molar part), ITX (two molar parts) and PAG1 (4 molar parts) were dissolved in DecNB (10,000 molar parts). The composition was rolled till a fully clear solution was formed. The composition was then spin coated in air at 3000 rpm (1 μm film thickness, measured after curing) or 500 rpm (˜7 μm film thickness) then exposed in air to 5 J/cm² at 395 nm at 25 or 40° C. as listed in Table 4. After a few hours, the resulting film was then dissolved in THF, and the polymer solution was analyzed by GC-MS for residual monomer. The results are summarized in Table 4. For comparison, the films were formed from the compositions of Comparative Examples 1 and 2 in accordance with the procedures set forth above and the results are also listed in Table 4. It is evident from the results presented in Table 4 that the composition of Comparative Example 2, which contained Pd680 of the prior art remained liquid and did not form a film. Whereas the film formed from Comparative Example 1 exhibited much lower curing of the composition as indicated by the presence of much higher amounts of the residual monomer in THF in the 1 m thick film.

TABLE 4

| | 1 μm, | 1 μm, | 7 μm, | 7 μm, |
|---|---|---|---|---|
| | 40° C. | 25° C. | 40° C. | 25° C. |
| Example No. | (ppth) | (ppth) | (ppth) | (ppth) |
| Example 10 | 14 | 21 | 10 | 16 |
| Comp. Example 1 | 43 | 64 | 8 | 9 |
| Comp. Example 2 | Remained | Remained | Remained | Remained |
| | Liquid | Liquid | Liquid | Liquid |

ppth—parts per thousand parts of DecNB measured by GC-MS

### Example 11

Thin Film Formation Under Air vs. Nitrogen

In a glass bottle, Pd657 (one molar part), ITX (two molar parts) and PAG1 (4 molar parts) were dissolved in DecNB (10,000 molar parts). The composition was rolled till a fully clear solution was formed. The composition was sparged with N₂ for 2 hours and placed into a N₂ purge box. The composition was then spin coated at 3000 rpm (1 μm film thickness) or 500 rpm (˜7 μm film thickness) then exposed to 5 J/cm⁻² at 395 nm at room temperature (˜25° C.). After a few hours, the resulting films and the composition was removed from the N₂ purge box. The films were then dissolved in THF, and the polymer solution was analyzed by GC-MS for residual monomer. The solutions were then spin coated again at 4000 rpm (1 μm film thickness) or 500 rpm (˜7 μm film thickness) then exposed to 5 J/cm⁻² at 395 nm at room temperature (˜25° C.) in air. The results are summarized in Table 5. These results demonstrate that the palladium compound of formula (I) of this invention is capable of curing films as thin as 1 μm while Pd680 of the prior art used in the composition of Comparative Example 2 will not cure thin films (<7 μm) in air. The results also demonstrate that Pd657, the palladium compound of this invention has higher conversion than Pd680 in thin films cured in air. Thus, the palladium compounds of this invention provide advantageous benefits over the compositions containing either Pd680 (i.e., composition of Comparative Example 2) or Pd520 (i.e., composition of Comparative Example 1) of the prior art.

TABLE 5

| | 1 μm, N₂ | 1 μm, air | 7 μm, N₂ | 7 μm, air |
|---|---|---|---|---|
| Example No. | (ppth) | (ppth) | (ppth) | (ppth) |
| Example 11 | 11 | 47 | 4 | 6 |
| Comp. Example 1 | 7 | 71 | 0.4 | 2.3 |
| Comp. Example 2 | 0.6 | 108 | 0.6 | 38 |

ppth—parts per thousand parts of DecNB measured by GC-MS

### Comparative Example 1

In a glass bottle, Pd520, a palladium compound of prior art (one molar part), ITX (two molar parts), PAG1 (4 molar parts) and HALS (0.5 molar parts) were dissolved in DecNB (10,000 molar parts). The composition was rolled till a fully clear solution was formed. This composition was then used in Examples 10 and 11.

### Comparative Example 2

In a glass bottle, Pd680, a palladium compound of prior art (one molar part), ITX (two molar parts) and PAG1 (4 molar parts) were dissolved in DecNB (10,000 molar parts). The composition was rolled till a fully clear solution was formed. This composition was then used in Examples 10 and 11.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A composition comprising:
a) a palladium compound of formula (I): 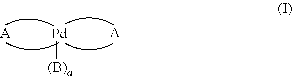
wherein:
a is an integer from 1 to 4, inclusive;
B is a heteroaromatic compound containing at least one nitrogen atom selected from the group consisting of substituted or unsubstituted pyridine, substituted or unsubstituted bipyridine, substituted or unsubstituted pyrazine, substituted or unsubstituted pyrimidine, substituted or unsubstituted pyridazine and substituted or unsubstituted oxazole, where each of the substituent is independently selected from the group consisting of methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl;
each A independently is a bidentate monoanionic ligand of formula (IA): 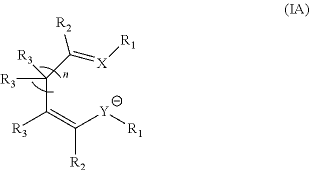
wherein:
n is an integer 0, 1 or 2;
X and Y are independently of each other selected from O, N and S;
R₁, R₂ and R₃ are the same or different and each independently selected from the group consisting of hydrogen, methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl; provided when either X or Y is O or S, R₁ does not exist;
b) a photoacid generator selected from the group consisting of:
a compound of formula (II): 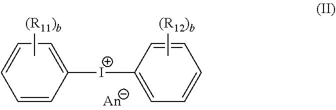
and 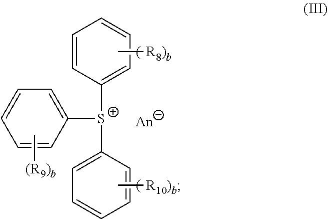
a compound of formula (III):
wherein:
b is an integer from 1 to 5, inclusive;
An^{⊖} is selected from the group consisting of Cl^{⊖}, Br^{⊖}, I^{⊖}, BF₄^{⊖}, tetrakis(pentafluorophenyl)borate, tetrakis(3,5-bis(trifluoromethyl)phenyl)borate, tetrakis(2-fluorophenyl)borate, tetrakis(3-fluorophenyl)borate, tetrakis(4-fluorophenyl)borate, tetrakis(3,5-difluorophenyl)borate, tetrakis(2,3,4,5-tetrafluorophenyl)borate, tetrakis(3,4,5,6-tetrafluorophenyl)borate, tetrakis(3,4,5-trifluorophenyl)borate, methyltris(perfluorophenyl)borate, ethyltris(perfluorophenyl)borate, phenyltris(perfluorophenyl)borate, tetrakis(1,2,2-trifluoroethylenyl)borate, tetrakis(4-tri-1-propylsilyltetrafluorophenyl)borate, tetrakis(4-dimethyl-tert-butylsilyltetrafluorophenyl)borate, (triphenylsiloxy)tris(pentafluorophenyl)borate, (octyloxy)tris(pentafluorophenyl)borate, tetrakis[3,5-bis[1-methoxy-2,2,2-trifluoro-1-(trifluoromethyl)ethyl]pheny-1]borate, tetrakis[3-[1-methoxy-2,2,2-trifluoro-1-(trifluoromethyl)ethyl]-5-(trifluoromethyl)phenyl]borate, and tetrakis[3-[2,2,2-trifluoro-1-(2,2,2-trifluoroethoxy)-1-(trifluoromethyl)-ethyl]-5-(trifluoromethyl)phenyl]borate,
PF₆^{⊖}, SbF₆^{⊖}, n-C₄F₉SO₃^{⊖}, CF₃SO₃^{⊖}, p-CH₃(C₆H₄)—SO₃^{⊖}, (CF₃SO₂)CH^{⊖} and (CF₃SO₂)N^{⊖};
R₈, R₉, R₁₀, Ru and R₁₂ are the same or different and each independently selected from the group consisting of halogen, methyl, ethyl, linear or branched (C₃-C₂₀)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl, (C₆-C₁₀)-aryloxy, (C₆-C₁₀)thioaryl, (C₁-C₆)alkanoyl(C₆-C₁₀)thioaryl, (C₁-C₆)alkoxy(C₆-C₁₀)aroyl(C₁-C₆)alkyl and (C₆-C₁₀)thioaryl-(C₆-C₁₀)diarylsulfonium salt;
c) one or more olefinic monomers of formula (IV): 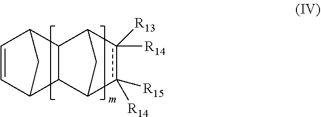
wherein:
m is an integer 0, 1 or 2; [symbol]
is a single bond or a double bond;
R₁₃, R₁₄, R₁₅ and R₁₆ are the same or different and each independently selected from the group consisting of hydrogen, halogen, a hydrocarbyl or halohydrocarbyl group selected from methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, epoxy, epoxy(C₁-C₁₂)alkyl, epoxy(C₁-C₁₂)alkoxy(C₁-C₁₂)alkyl, (C₃-C₁₂)cycloalkyl, epoxy(C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, (C₁-C₁₆)alkoxy(C₁-C₁₂)alkyl, perfluoro(C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy, (C₆-C₁₀)aryl(C₁-C₆)alkoxy, perfluoro(C₆-C₁₀)aryloxy,
perfluoro(C₆-C₁₀)aryl(C₁-C₃)alkoxy,
a group of formula (A):
—Z-Aryl (A);
a group of formula (A1): 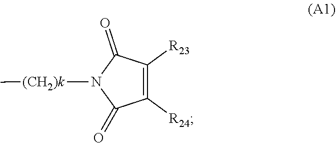
a group of formula (A2): 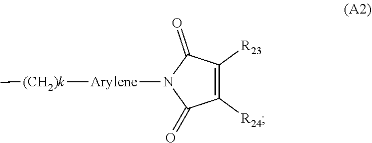
a group of formula (A3): 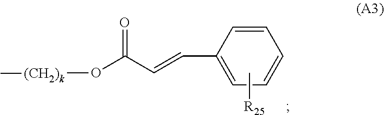
and
a group of formula (A4): 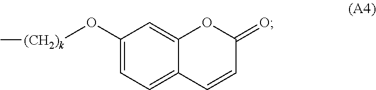
wherein:
Z is selected from the group consisting of:
O, CO, C(O)O, OC(O), OC(O)O, S, (CR₁₇R₁₈)_{d}, O(CR₁₇R₁₈)_{d}, (CR₁₇R₁₈)_{d}O, C(O)(CR₁₇R₁₈)_{d}, (CR₁₇R₁₈)_{d}C(O), C(O)O(CR₁₇R₁₈)_{d}, (CR₁₇R₁₈)_{d}C(O)O, OC(O)(CR₁₇R₁₈)_{d}, (CR₁₇R₁₈)_{d}OC(O), (CR₁₇R₁₈)_{d}OC(O)O, (CR₁₇R₁₈)_{d}OC(O)O(CR₁₇R₁₈)_{d}, OC(O)O(CR₁₇R₁₈)_{d}, S(CR₁₇R₁₈)_{d}, (CR₁₇R₁₈)_{d}S, (SiR₁₇R₁₈)_{d}, O(SiR₁₇R₁₈)_{d}, and (SiR₁₇R₁₈)_{d}O, where
R₁₇ and R₁₈ are the same or different and each independently selected from hydrogen, methyl, ethyl, linear or branched (C₃-C₁₂)alkyl, substituted or unsubstituted (C₆-C₁₄)aryl, methoxy, ethoxy, linear or branched (C₃-C₆)alkyloxy, (C₂-C₆)acyl, (C₂-C₆)acyloxy, and substituted or unsubstituted (C₆-C₁₄)aryloxy; and
d is an integer from 0 to 12, inclusive;
Aryl is selected from the group consisting of substituted or unsubstituted phenyl, substituted or unsubstituted biphenyl and substituted or unsubstituted naphthyl, substituted or unsubstituted terphenyl, substituted or unsubstituted anthracenyl substituted or unsubstituted fluorenyl, wherein the substituents are selected from the group consisting of halogen, methyl, ethyl, linear or branched (C₃-C₆)alkyl, perfluoro(C₁-C₁₂)alkyl, (C₃-C₁₂)cycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, perfluoro(C₁-C₁₂)alkoxy, (C₃-C₁₂)cycloalkoxy, (C₆-C₁₀)aryloxy, (C₆-C₁₀)aryl(C₁-C₆)alkoxy, perfluoro(C₆-C₁₀)aryloxy and perfluoro(C₆-C₁₀)aryl(C₁-C₃)alkoxy;
k is an integer from 1 to 12, inclusive;
R₂₃, R₂₄ and R₂₅ are the same or different and each independently selected from the group consisting of hydrogen, methyl, ethyl, linear or branched (C₃-C₁₂)alkyl, a fluorinated alkyl of formula C_{q}HₓF_{y}, where q is from 1 to 16, x is from 0 to 32, y is from 1 to 33 and sum of x+y=2q+1, methoxy, ethoxy, linear or branched (C₃-C₁₂)alkoxy, (C₃-C₁₂)alkoxy(C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl and perfluoro(C₆-C₁₀)aryl(C₁-C₆)alkyl; or
R₂₃ and R₂₄ taken together with the intervening carbon atoms to which they are attached to form a substituted or unsubstituted (C₅-C₁₄)cyclic, (C₅-C₁₄)bicyclic or (C₅-C₁₄)tricyclic ring; and Arylene is substituted or unsubstituted bivalent (C₆-C₁₄)aryl;
or
one of R₁₃ and R₁₄ taken together with one of R₁₅ and R₁₆ and the carbon atoms to which they are attached to form a substituted or unsubstituted (C₅-C₁₄)cyclic, (C₅-C₁₄)bicyclic or (C₅-C₁₄)tricyclic ring;
and
d) a photosensitizer.

2. The composition according to claim 1, wherein said olefinic monomer of formula (IV) is having:
m=0 or 1; [symbol]
is a single bond;
R₁₃, R₁₄, R₁₅ and R₁₆ is selected from the group consisting of hydrogen, ethyl, butyl, n-propyl, n-butyl, n-pentyl, n-hexyl, n-heptyl, n-octyl, n-nonyl, n-decyl, n-dodecyl, cyclohexyl, epoxycyclohexyl, phenylethyl, phenylbutyl, phenoxyethyl, biphenyloxyethyl and biphenyloxybutyl.

3. The composition according to claim 1, wherein said composition comprises at least two different monomers of formula (IV) and is in a clear liquid state having a viscosity below 100 centipoise.

4. The composition according to claim 1, wherein said composition contains said two distinctive monomers of formula (IV) in a molar ratio of from 1:99 to 99:1.

5. The composition according to claim 1, wherein said composition forms a substantially transparent film when exposed to suitable actinic radiation.

6. The composition according to claim 5, wherein said film has a transmission of equal to or higher than 90 percent of the visible light.

7. The composition according to claim 1, wherein said bidentate monoanionic ligand is selected from the group consisting of:

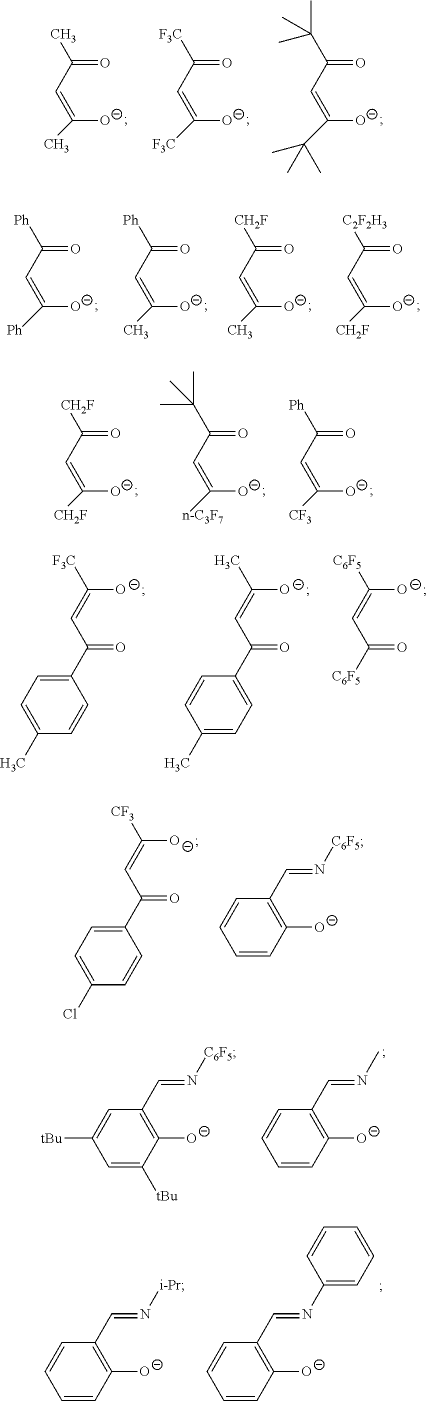

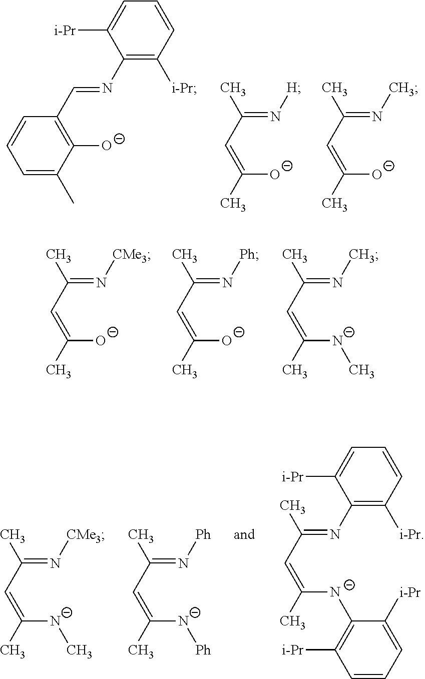

8. The composition according to claim 1 further comprising one or more monomers selected from the group consisting of a monomer of formula (V) and a monomer of formula (VI), wherein
said monomer of formula (V) is: 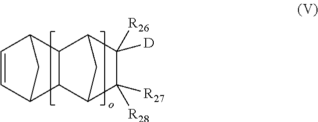
wherein:
o is an integer from 0 to 2, inclusive;
D is SiR₂₉R₃₀R₃₁ or a group selected from:
—(CH₂)_{c}—O—SiR₂₉R₃₀R₃₁ (E);
—(CH₂)_{c}—SiR₂₉R₃₀R₃₁ (F); and
—(SiR₂₉R₃₀)_{c}—O—SiR₂₉R₃₀R₃₁ (G); wherein
c is an integer from 1 to 10, inclusive, and where one or more of CH₂ is optionally substituted with (C₁-C₁₀)alkyl or (C₁-C₁₀)perfluoroalkyl;
R₂₆, R₂₇ and R₂₈ are the same or different and independently of each other selected from the group consisting of hydrogen, halogen and hydrocarbyl, where hydrocarbyl is selected from the group consisting of methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy; and
R₂₉, R₃₀ and R₃₁ are each independently of one another methyl, ethyl, linear or branched (C₃-C₉)alkyl, substituted or unsubstituted (C₆-C₁₄)aryl, methoxy ethoxy, linear or branched (C₃-C₉)alkoxy or substituted or unsubstituted (C₆-C₁₄)aryloxy;
said monomer of formula (VI) is: 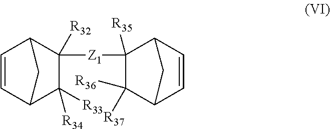
wherein:
Z₁ is selected from the group consisting of substituted or unsubstituted (C₁-C₁₂)alkylene, —(CH₂)ₑO(CH₂)_{f}—, —(CH₂)ₑ(SiR₃₈R₃₉)(OSiR₄₀R₄₁)_{g}(CH₂)_{f}— where e, f and g are independently integers from 0 to 6, inclusive, R₃₈, R₃₉, R₄₀ and R₄₁ are the same or different and independently of each other selected from methyl, ethyl, linear or branched (C₃-C₁₂)alkyl, and an arylene selected from the following: 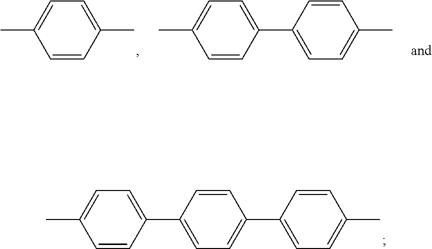
R₃₂, R₃₃, R₃₄, R₃₅, R₃₆ and R₃₇ are the same or different and independently of each other selected from the group consisting of hydrogen, halogen and hydrocarbyl, where hydrocarbyl is selected from the group consisting of methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)-aryloxy.

9. The composition according to claim 1, wherein the monomer of formula (IV) is selected from the group consisting of: 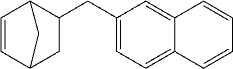 [SMILES: C1=CC2CC1CC2Cc1ccc2ccccc2c1]
2-(bicyclo[2.2.1]hept-5-en-2-ylmethyl)naphthalene; 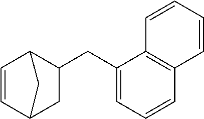 [SMILES: C1=CC2CC1CC2Cc1cccc2ccccc12]
1-(bicyclo[2.2.1]hept-5-en-2-ylmethyl)naphthalene; 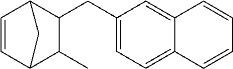 [SMILES: CC1C2C=CC(C2)C1Cc1ccc2ccccc2c1]
2-((3-methylbicyclo[2.2.1]hept-5-en-2-yl)methyl)naphthalene; 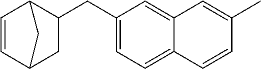 [SMILES: Cc1ccc2ccc(CC3CC4C=CC3C4)cc2c1]
2-(bicyclo[2.2.1]hept-5-en-2-ylmethyl)-7-methylnaphthalene; 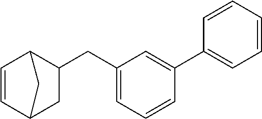 [SMILES: C1=CC2CC1CC2Cc1cccc(-c2ccccc2)c1]
5-([1,1′-biphenyl]-3-ylmethyl)bicyclo[2.2.1]hept-2-ene; 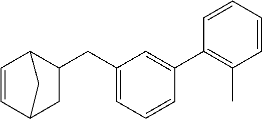 [SMILES: Cc1ccccc1-c1cccc(CC2CC3C=CC2C3)c1]
5-((2′-methyl-[1,1′-biphenyl]-3-yl)methyl)bicyclo[2.2.1]hept-2-ene; 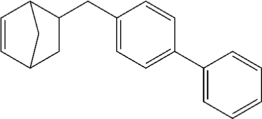 [SMILES: C1=CC2CC1CC2Cc1ccc(-c2ccccc2)cc1]
5-([1,1′-biphenyl]-4-ylmethyl)bicyclo[2.2.1]hept-2-ene: 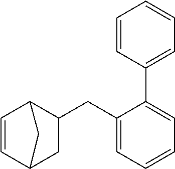 [SMILES: C1=CC2CC1CC2Cc1ccccc1-c1ccccc1]
5-([1,1′-biphenyl]-2-ylmethyl)bicyclo[2.2.1]hept-2-ene; 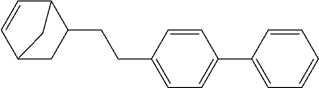 [SMILES: C1=CC2CC1CC2CCc1ccc(-c2ccccc2)cc1]
5-(2-([1,1′-biphenyl]-4-yl)ethyl)bicyclo[2.2.1]hept-2-ene (NBEtPhPh); 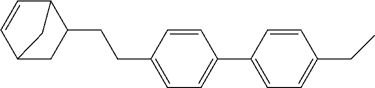 [SMILES: CCc1ccc(-c2ccc(CCC3CC4C=CC3C4)cc2)cc1]
5-(2-(4′-ethyl-[1,1′-biphenyl]-4-yl)ethyl)bicyclo[2.2.1]hept-2-ene; 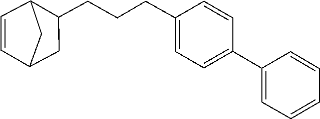 [SMILES: C1=CC2CC1CC2CCCc1ccc(-c2ccccc2)cc1]
5-(3-([1,1′-biphenyl]-4-yl)propyl)bicyclo[2.2.1]hept-2-ene; 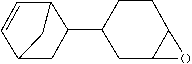 [SMILES: C1=CC2CC1CC2C1CCC2OC2C1]
3-(bicyclo[2.2.1]hept-5-en-2-yl)-7-oxabicyclo[4.1.0]heptane (CHEpNB); 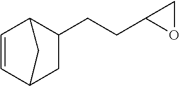 [SMILES: C1=CC2CC1CC2CCC1CO1]
2-(2-(bicyclo[2.2.1]hept-5-en-2-yl)ethyl)oxirane (EBNB); 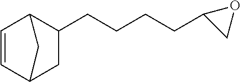 [SMILES: C1=CC2CC1CC2CCCCC1CO1]
2-(4-(bicyclo[2.2.1]hept-5-en-2-yl)butyl)oxirane (EHNB);
2-(6-(bicyclo[2.2.1]hept-5-en-2-yl)hexyl)oxirane (EONB); 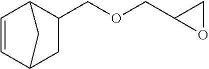 [SMILES: C1=CC2CC1CC2COCC1CO1]
2-((bicyclo[2.2.1]hept-5-en-2-ylmethoxy)methyl)oxirane (MGENB); 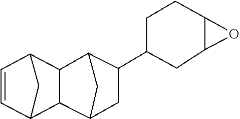 [SMILES: C1=CC2CC1C1C3CC(C4CCC5OC5C4)C(C3)C21]
3-(1,2,3,4,4a,5,8,8a-octahydro-1,4:5,8-dimethanonaphthalen-2-yl)-7-oxabicyclo[4.1.0]heptane (CHEpTD); 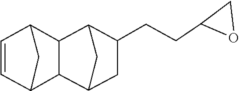 [SMILES: C1=CC2CC1C1C3CC(CCC4CO4)C(C3)C21]
2-(2-(1,2,3,4,4a,5,8,8a-octahydro-1,4:5,8-dimethanonaphthalen-2-yl)ethyl)oxirane (EBTD); 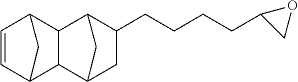 [SMILES: C1=CC2CC1C1C3CC(CCCCC4CO4)C(C3)C21]
2-(4-(1,2,3,4,4a,5,8,8a-octahydro-1,4:5,8-dimethanonaphthalen-2-yl)butyl)oxirane (EHTD); 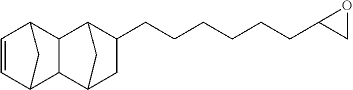 [SMILES: C1=CC2CC1C1C3CC(CCCCCCC4CO4)C(C3)C21]
2-(6-(1,2,3,4,4a,5,8,8a-octahydro-1,4:5,8-dimethanonaphthalen-2-yl)hexyl)oxirane (EOTD); 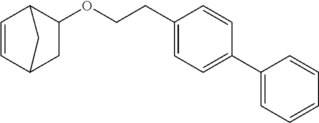 [SMILES: C1=CC2CC1CC2OCCc1ccc(-c2ccccc2)cc1]
5-(2-([1,1′-biphenyl]-4-yl)ethoxy)bicyclo[2.2.1]hept-2-ene; 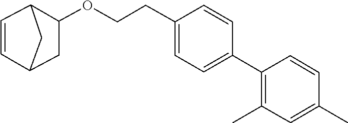 [SMILES: Cc1ccc(-c2ccc(CCOC3CC4C=CC3C4)cc2)c(C)c1]
5-(2-(2′,4′-dimethyl-[1,1′-biphenyl]-4-yl)ethoxy)bicyclo[2.2.1]hept-2-ene; 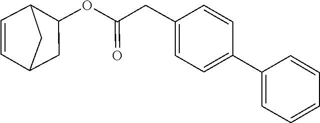 [SMILES: O=C(Cc1ccc(-c2ccccc2)cc1)OC1CC2C=CC1C2]
bicyclo[2.2.1]hept-5-en-2-yl 2-([1,1′-biphenyl]-4-yl)acetate; 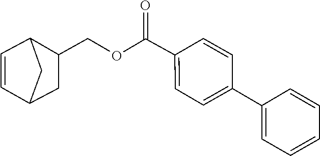 [SMILES: O=C(OCC1CC2C=CC1C2)c1ccc(-c2ccccc2)cc1]
bicyclo[2.2.1]hept-5-en-2-ylmethyl [1,1′-biphenyl]-4-carboxylate; 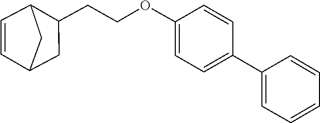 [SMILES: C1=CC2CC1CC2CCOc1ccc(-c2ccccc2)cc1]
5-(2-([1,1′-biphenyl]-4-yloxy)ethyl)bicyclo[2.2.1]hept-2-ene; 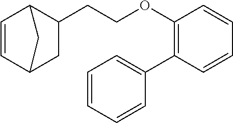 [SMILES: C1=CC2CC1CC2CCOc1ccccc1-c1ccccc1]
5-(2-([1,1′-biphenyl]-2-yloxy)ethyl)bicyclo[2.2.1]hept-2-ene (NBEtOPhPh); 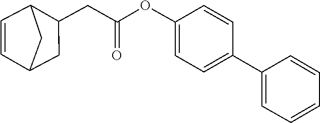 [SMILES: O=C(CC1CC2C=CC1C2)Oc1ccc(-c2ccccc2)cc1]
[1,1′-biphenyl]-4-yl 2-(bicyclo[2.2.1]hept-5-en-2-yl)acetate; 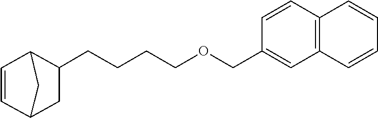 [SMILES: C1=CC2CC1CC2CCCCOCc1ccc2ccccc2c1]
2-((4-(bicyclo[2.2.1]hept-5-en-2-yl)butoxy)methyl)naphthalene; 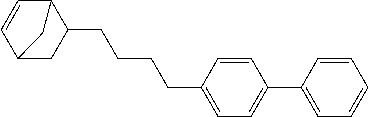 [SMILES: C1=CC2CC1CC2CCCCc1ccc(-c2ccccc2)cc1]
5-(4-([1,1′-biphenyl]-4-yl)butyl)bicyclo[2.2.1]hept-2-ene; 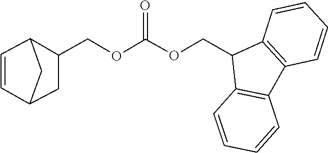 [SMILES: O=C(OCC1c2ccccc2-c2ccccc21)OCC1CC2C=CC1C2]
(9H-fluoren-9-yl)methyl (bicyclo[2.2.1]hept-5-en-2-ylmethyl) carbonate; 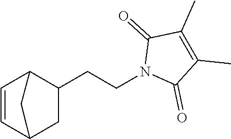 [SMILES: CC1=C(C)C(=O)N(CCC2CC3C=CC2C3)C1=O]
1-(4-bicyclo[2.2.1]hept-5-en-2-ylethyl)-3,4-dimethyl-1H-pyrrole-2,5-dione; 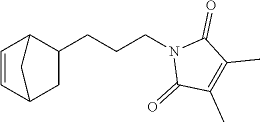 [SMILES: CC1=C(C)C(=O)N(CCCC2CC3C=CC2C3)C1=O]
1-(4-bicyclo[2.2.1]hept-5-en-2-ylpropyl)-3,4-dimethyl-1H-pyrrole-2,5-dione; 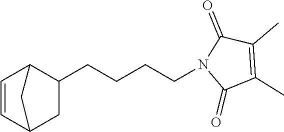 [SMILES: CC1=C(C)C(=O)N(CCCCC2CC3C=CC2C3)C1=O]
1-(4-bicyclo[2.2.1]hept-5-en-2-ylbutyl)-3,4-dimethyl-1H-pyrrole-2,5-dione; 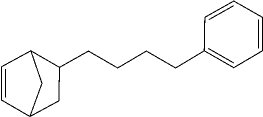 [SMILES: C1=CC2CC1CC2CCCCc1ccccc1]
5-(4-phenylbutyl)bicyclo[2.2.1]hept-2-ene; 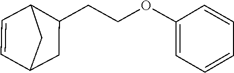 [SMILES: C1=CC2CC1CC2CCOc1ccccc1]
5-(2-phenoxyethyl)bicyclo[2.2.1]hept-2-ene; 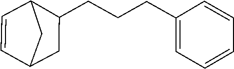 [SMILES: C1=CC2CC1CC2CCCc1ccccc1]
5-(3-phenylpropyl)bicyclo[2.2.1]hept-2-ene; 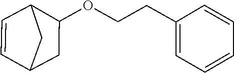 [SMILES: C1=CC2CC1CC2OCCc1ccccc1]
5-phenethoxybicyclo[2.2.1]hept-2-ene; 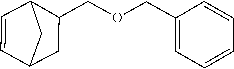 [SMILES: C1=CC2CC1CC2COCc1ccccc1]
5-((benzyloxy)methyl)bicyclo[2.2.1]hept-2-ene; 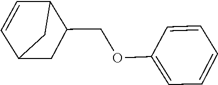 [SMILES: C1=CC2CC1CC2COc1ccccc1]
5-(phenoxymethyl)bicyclo[2.2.1]hept-2-ene; 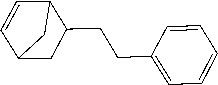 [SMILES: C1=CC2CC1CC2CCc1ccccc1]
5-phenethylbicyclo[2.2.1]hept-2-ene; 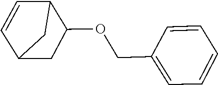 [SMILES: C1=CC2CC1CC2OCc1ccccc1]
5-(benzyloxy)bicyclo[2.2.1]hept-2-ene; 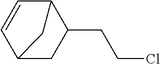
5-(2-chloroethyl)bicyclo[2.2.1]hept-2-ene (NBEtCl); 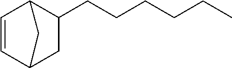
5-hexylbicyclo[2.2.1]hept-2-ene (HexylNB); 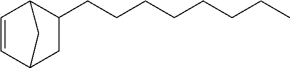
5-octylbicyclo[2.2.1]hept-2-ene (OctNB); 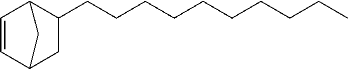 [SMILES: CCCCCCCCCCC1CC2C=CC1C2]
5-decylbicyclo[2.2.1]hept-2-ene (DecNB); 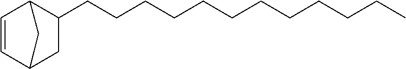 [SMILES: CCCCCCCCCCCCC1CC2C=CC1C2]
5-dodecylbicyclo[2.2.1]hept-2-ene (DoDecNB); and 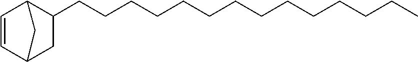 [SMILES: CCCCCCCCCCCCCCC1CC2C=CC1C2]
5-tetradecylbicyclo[2.2.1]hept-2-ene (TetraDecNB).

10. The composition according to claim 8, wherein the monomer of formula (V) or the monomer of formula (VI) is selected from the group consisting of: 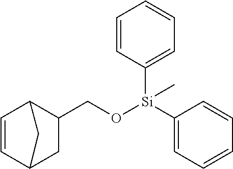 [SMILES: C[Si](OCC1CC2C=CC1C2)(c1ccccc1)c1ccccc1]
(bicyclo[2.2.1]hept-5-en-2-ylmethoxy)(methyl)diphenylsilane (NBCH₂OSiMePh₂); 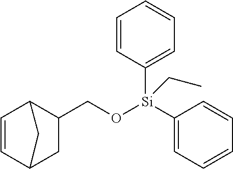 [SMILES: CC[Si](OCC1CC2C=CC1C2)(c1ccccc1)c1ccccc1]
(bicyclo[2.2.1]hept-5-en-2-ylmethoxy)(ethyl)diphenylsilane; 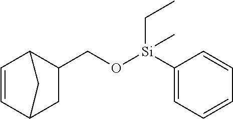 [SMILES: CC[Si](C)(OCC1CC2C=CC1C2)c1ccccc1]
(bicyclo[2.2.1]hept-5-en-2-ylmethoxy)(ethyl)(methyl)(phenyl)silane; 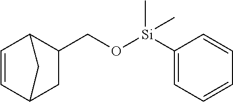 [SMILES: C[Si](C)(OCC1CC2C=CC1C2)c1ccccc1]
(bicyclo[2.2.1]hept-5-en-2-ylmethoxy)dimethyl(phenyl)silane; 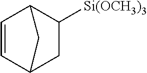
bicyclo[2.2.1]hept-5-en-2-yltrimethoxysilane; 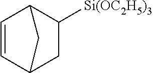
bicyclo[2.2.1]hept-5-en-2-yltriethoxysilane (NBSi(OC₂H₅)₃; 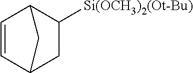
bicyclo[2.2.1]hept-5-en-2-yl(tert-butoxy)dimethoxysilane; 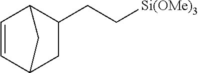
(2-(bicyclo[2.2.1]hept-5-en-2-yl)ethyl)trimethoxysilane; 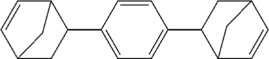 [SMILES: C1=CC2CC1CC2c1ccc(C2CC3C=CC2C3)cc1]
1,4-di(bicyclo[2.2.1]hept-5-en-2-yl)benzene; 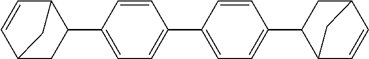 [SMILES: C1=CC2CC1CC2c1ccc(-c2ccc(C3CC4C=CC3C4)cc2)cc1]
4,4′-di(bicyclo[2.2.1]hept-5-en-2-yl)-1,1′-biphenyl; 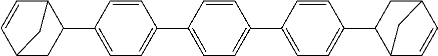 [SMILES: C1=CC2CC1CC2c1ccc(-c2ccc(-c3ccc(C4CC5C=CC4C5)cc3)cc2)cc1]
4,4″-di(bicyclo[2.2.1]hept-5-en-2-yl)-1,1′:4′,1″-terphenyl; 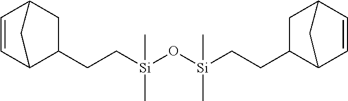 [SMILES: C[Si](C)(CCC1CC2C=CC1C2)O[Si](C)(C)CCC1CC2C=CC1C2]
1,3-bis(norbornenylethyl)-1,1,3,3-tetramethyldisiloxane; and 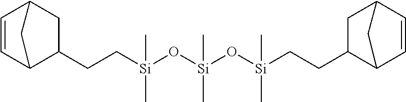 [SMILES: C[Si](C)(CCC1CC2C=CC1C2)O[Si](C)(C)O[Si](C)(C)CCC1CC2C=CC1C2]
1,5-bis(norbornenylethyl)-1,1,3,3,5,5-hexamethyltrisiloxane.

11. The composition according to claim 1, wherein the palladium compound of formula (I) is selected from the group consisting of: 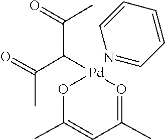
palladium bis(acetylacetonate)pyridine (Pd384); 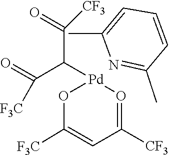
palladium bis(hexafluoroacetylacetonate)-2,6-dimethylpyridine (Pd628); 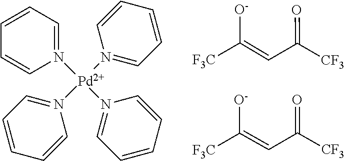
palladium bis(hexafluoroacetylacetonate)tetrapyridine (Pd837); 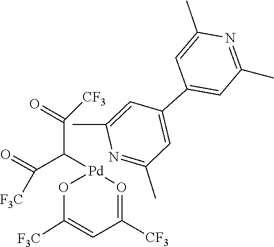
palladium bis(hexafluoroacetylacetonate)-2,2′,6,6′-tetramethyl-4,4′-bipyridine (Pd733); 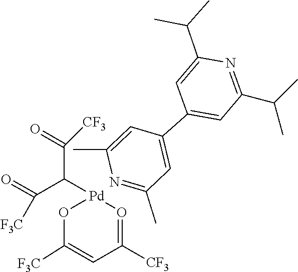
palladium bis(hexafluoroacetylacetonate)-2,6-dimethyl-2′,6′-diisopropyl-4,4′-bipyridine (Pd788); 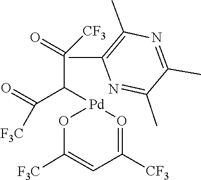
palladium bis(hexafluoroacetylacetonate)-2,3,5,6-tetramethylpyrazine (Pd657); 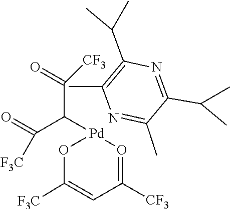
palladium bis(hexafluoroacetylacetonate)-2,3-dimethyl-5,6-diisopropylpyrazine (Pd712); 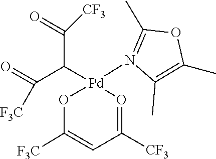
palladium bis(hexafluoroacetylacetonate)-2,4,5-trimethyloxazole (Pd631); and 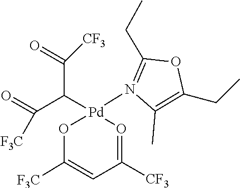
palladium bis(hexafluoroacetylacetonate)-4-methyl-2,5-diethyloxazole (Pd656).

12. The composition according to claim 1, wherein the compound of formula (II) or the compound of formula (III) is selected from the group consisting of: 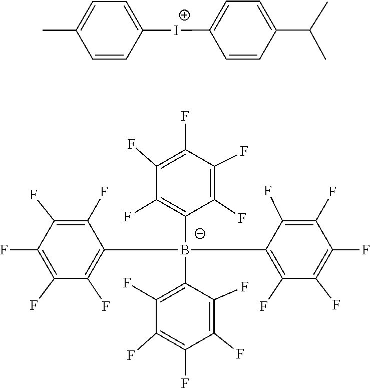 [SMILES: Cc1ccc([I+]c2ccc(C(C)C)cc2)cc1 ; Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F]
tolylcumyliodonium-tetrakis pentafluorophenylborate; 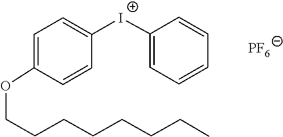 [SMILES: CCCCCCCCOc1ccc([I+]c2ccccc2)cc1 ; "PF6"]
4-(octyloxy)phenyl)(phenyl)iodonium hexafluorophosphate (OPPI—PF₆); 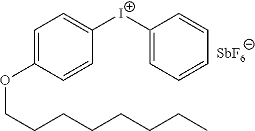
4-(octyloxy)phenyl)(phenyl)iodonium hexafluoroantimonate (OPPI—SBF₆); 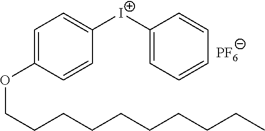
4-(decyloxy)phenyl)(phenyl)iodonium hexafluorophosphate (DPPI-PF₆); 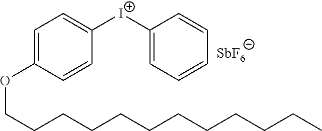
4-(dodecyloxy)phenyl)(phenyl)iodonium hexafluoroantimonate (DoPPI-SBF₆); 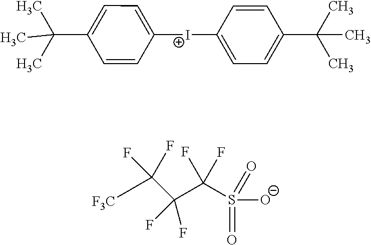 [SMILES: CC(C)(C)c1ccc([I+]c2ccc(C(C)(C)C)cc2)cc1 ; O=S(=O)([O-])C(F)(F)C(F)(F)C(F)(F)C(F)(F)F]
bis(4-tert-butylphenyl)iodonium perfluoro-1-butanesulfonate; 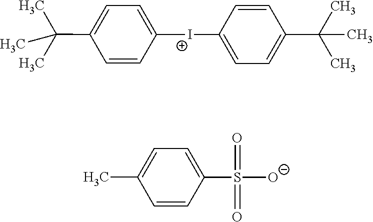
bis(4-tert-butylphenyl)iodonium p-toluenesulfonate; 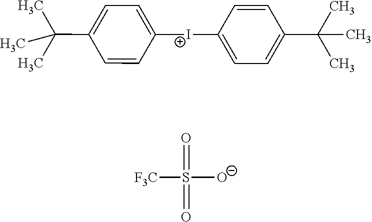 [SMILES: CC(C)(C)c1ccc([I+]c2ccc(C(C)(C)C)cc2)cc1 ; O=S(=O)([O-])C(F)(F)F]
bis(4-tert-butylphenyl)iodonium triflate; 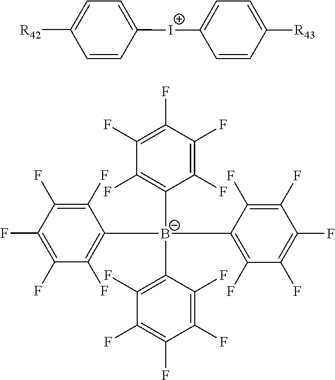
where R₄₂ and R₄₃ are the same or different and each independently selected from linear or branched (C₁₀-C₁₃)alkyl; 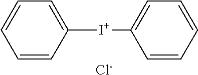 [SMILES: c1ccc([I+]c2ccccc2)cc1 ; [Cl-]]
diphenyliodonium chloride; 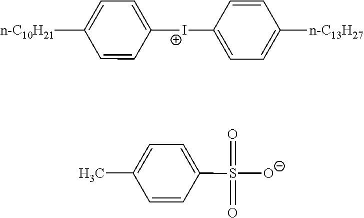
n-decylphenyl-n-tridecylphenyliodonium p-toluenesulfonate; 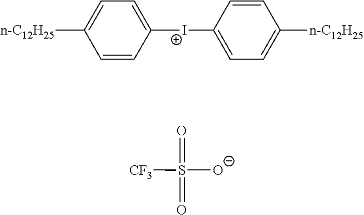
bis(n-dodecylphenyl)iodonium triflate; 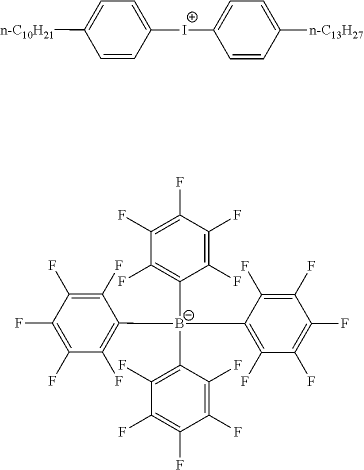
4-n-decylphenyl-4′-n-tridecylphenyliodonium tetrakis(pentafluorophenyl)borate; 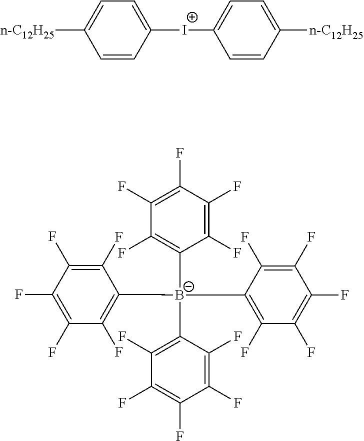
di(4-n-dodecylphenyl)iodonium tetrakis(pentafluorophenyl)borate; 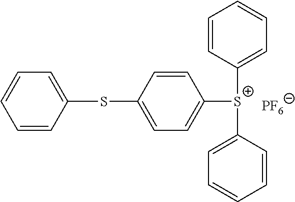
(4-thiophenyl)phenyl-diphenylsulfonium hexafluorophosphate; 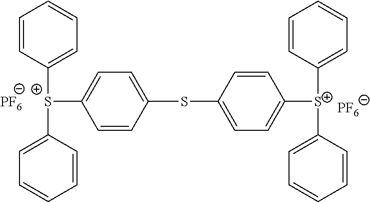
bis-(triphenylsulfonium) sulfide bis-hexafluorophosphate; 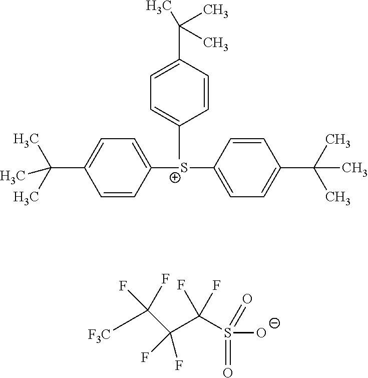
tris(4-tert-butylphenyl)sulfonium perfluoro-1-butanesulfonate; 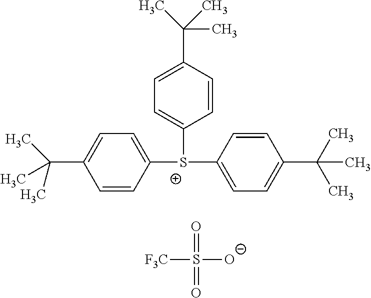 [SMILES: CC(C)(C)c1ccc([S+](c2ccc(C(C)(C)C)cc2)c2ccc(C(C)(C)C)cc2)cc1 ; O=S(=O)([O-])C(F)(F)F]
tris(4-tert-butylphenyl)sulfonium triflate; 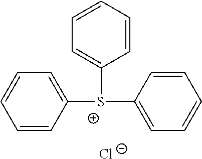 [SMILES: c1ccc([S+](c2ccccc2)c2ccccc2)cc1 ; [Cl-]]
triphenylsulfonium chloride; 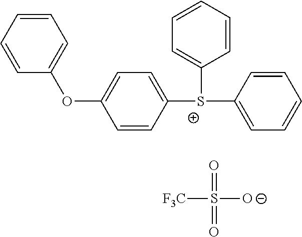 [SMILES: c1ccc(Oc2ccc([S+](c3ccccc3)c3ccccc3)cc2)cc1 ; O=S(=O)([O-])C(F)(F)F]
(4-phenoxyphenyl)diphenylsulfonium triflate; 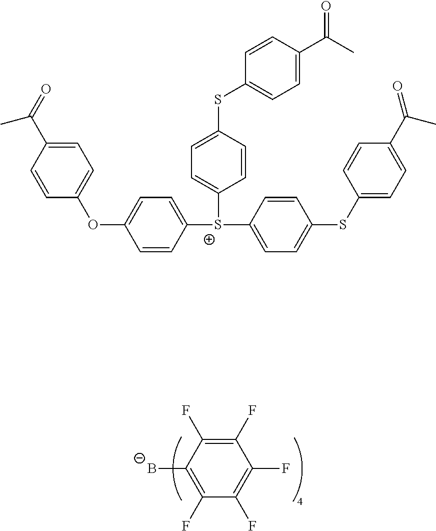
tris(4-((4-acetylphenyl)thio)phenyl)sulfonium tetrakis-pentafluorophenylborate; 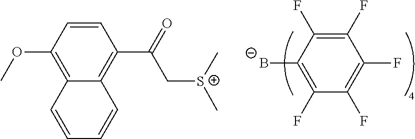
(2-(4-methoxynaphthalen-1-yl)-2-oxoethyl)dimethylsulfonium tetrakis-pentafluorophenylborate; and 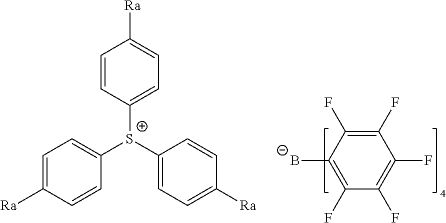
tri(4-alkylphenyl)sulfonium tetrafluoroborates, where each Rₐ is independently selected from linear or branched (C₁₀-C₁₃)alkyl.

13. The composition according to claim 1, wherein the photosensitizer is a compound of formula (VII) or a compound of formula (VIII): 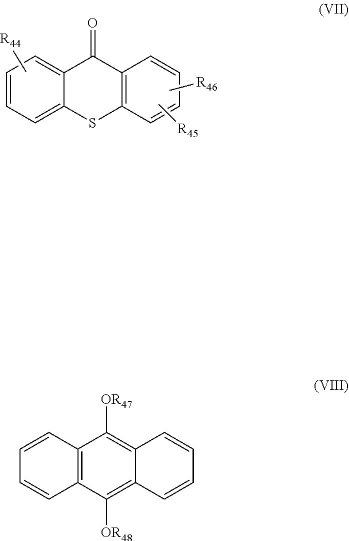
wherein
R₄₄, R₄₅ and R₄₆ are the same or different and independently of each other selected from the group consisting of hydrogen, halogen, hydroxy, NO₂, NH₂, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl, (C₆-C₁₀)-aryloxy, C(O)(C₁-C₆)alkyl, COOH, C(O)O(C₁-C₆)alkyl, and SO₂(C₆-C₁₀)aryl;
R₄₇ and R₄₈ are the same or different and independently of each other selected from the group consisting of methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl and (C₆-C₁₀)aryl(C₁-C₃)alkyl.

14. The composition according to claim 1, wherein the compound of formula (VII) or the compound of formula (VIII) is selected from the group consisting of: 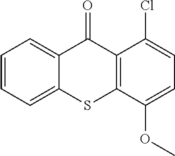 [SMILES: COc1ccc(Cl)c2c(=O)c3ccccc3sc12]
1-chloro-4-methoxy-9H-thioxanthen-9-one; 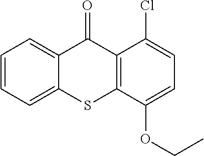 [SMILES: CCOc1ccc(Cl)c2c(=O)c3ccccc3sc12]
1-chloro-4-ethoxy-9H-thioxanthen-9-one; 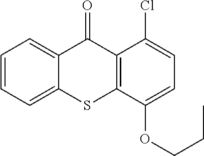 [SMILES: CCCOc1ccc(Cl)c2c(=O)c3ccccc3sc12]
1-chloro-4-propoxy-9H-thioxanthen-9-one; 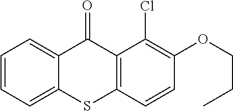 [SMILES: CCCOc1ccc2sc3ccccc3c(=O)c2c1Cl]
1-chloro-2-propoxy-9H-thioxanthen-9-one; 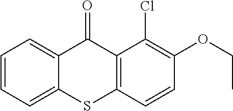 [SMILES: CCOc1ccc2sc3ccccc3c(=O)c2c1Cl]
1-chloro-2-ethoxy-9H-thioxanthen-9-one; 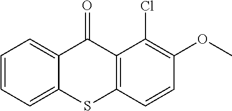 [SMILES: COc1ccc2sc3ccccc3c(=O)c2c1Cl]
1-chloro-2-methoxy-9H-thioxanthen-9-one; 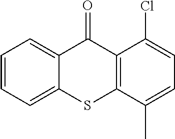 [SMILES: Cc1ccc(Cl)c2c(=O)c3ccccc3sc12]
1-chloro-4-methyl-9H-thioxanthen-9-one; 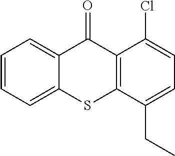 [SMILES: CCc1ccc(Cl)c2c(=O)c3ccccc3sc12]
1-chloro-4-ethyl-9H-thioxanthen-9-one; 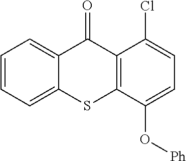 [SMILES: O=c1c2ccccc2sc2c(Oc3ccccc3)ccc(Cl)c12]
1-chloro-4-phenoxy-9H-thioxanthen-9-one; 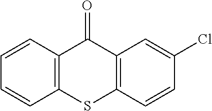 [SMILES: O=c1c2ccccc2sc2ccc(Cl)cc12]
2-chlorothioxanthen-9-one (CTX); 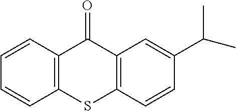 [SMILES: CC(C)c1ccc2sc3ccccc3c(=O)c2c1]
2-isopropyl-9H-thioxanthen-9-one (ITX); 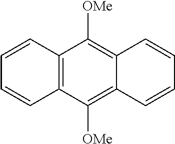 [SMILES: COc1c2ccccc2c(OC)c2ccccc12]
9,10-dimethoxyanthracene (DMA); 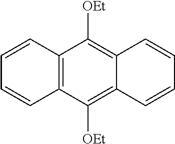 [SMILES: CCOc1c2ccccc2c(OCC)c2ccccc12]
9,10-diethoxyanthracene (DEA); and 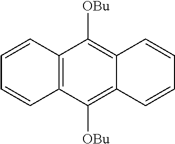
9,10-diethoxyanthracene (DBA).

15. The composition according to claim 1, which is selected from the group consisting of:
5-phenethylbicyclo[2.2.1]hept-2-ene (PENB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(hexafluoroacetylacetonate)-tetrapyridine (Pd837), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,6-dimethylpyridine (Pd628), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,3,5,6-tetramethylpyrazine (Pd657), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-hexylbicyclo[2.2.1]hept-2-ene (HexylNB), palladium bis(hexafluoroacetylacetonate)-2,2′,6,6′-tetramethyl-4,4′-bipyridine (Pd733), di(4-n-dodecylphenyl)iodonium tetrakis(pentafluorophenyl)borate and 2-isopropyl-9H-thioxanthen-9-one (ITX); and
5-decylbicyclo[2.2.1]hept-2-ene (DecNB), palladium bis(hexafluoroacetylacetonate)-2,4,5-trimethyloxazole (Pd631), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX).

16. A kit for forming a substantially transparent film dispensed therein a composition comprising:
a) a palladium compound of formula (I): 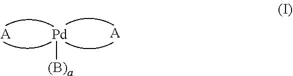
wherein:
a is an integer from 1 to 4, inclusive;
B is a heteroaromatic compound containing at least one nitrogen atom selected from the group consisting of substituted or unsubstituted pyridine, substituted or unsubstituted bipyridine, substituted or unsubstituted pyrazine, substituted or unsubstituted pyrimidine, substituted or unsubstituted pyridazine and substituted or unsubstituted oxazole, where each of the substituent is independently selected from the group consisting of methyl, ethyl, linear or branched (C₃-C₁₆)alkyl, a fluorinated alkyl of formula C_{q}H_{X}F_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl;
each A independently is a bidentate monoanionic ligand of formula (IA): 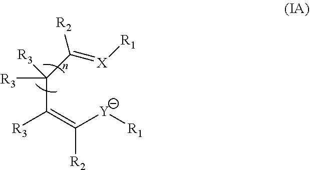
wherein:
n is an integer 0, 1 or 2;
X and Y are independently of each other selected from O, N and S;
R₁, R₂ and R₃ are the same or different and each independently selected from the group consisting of hydrogen, methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, (C₃-C₁₀)cycloalkyl, (C₆-C₁₀)aryl(C₁-C₁₆)alkyl and substituted or unsubstituted (C₆-C₁₀)aryl; provided when either X or Y is O or S, R₁ does not exist;
b) a photoacid generator selected from the group consisting of:
a compound of formula (II): 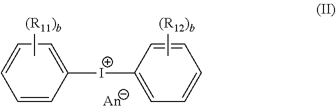
and
a compound of formula (III): 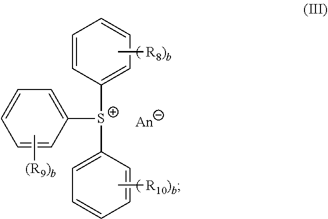
wherein:
b is an integer from 1 to 5, inclusive;
An^{⊖} is selected from the group consisting of Cl^{⊖}, Br^{⊖}, I^{⊖}, BF₄^{⊖} tetrakis(pentafluorophenyl)borate, tetrakis(3,5-bis(trifluoromethyl)phenyl)borate, tetrakis(2-fluorophenyl)borate, tetrakis(3-fluorophenyl)borate, tetrakis(4-fluorophenyl)borate, tetrakis(3,5-difluorophenyl)borate, tetrakis(2,3,4,5-tetrafluorophenyl)borate, tetrakis(3,4,5,6-tetrafluorophenyl)borate, tetrakis(3,4,5-trifluorophenyl)borate, methyltris(perfluorophenyl)borate, ethyltris(perfluorophenyl)borate, phenyltris(perfluorophenyl)borate, tetrakis(1,2,2-trifluoroethylenyl)borate, tetrakis(4-tri-1-propylsilyltetrafluorophenyl)borate, tetrakis(4-dimethyl-tert-butylsilyltetrafluorophenyl)borate, (triphenylsiloxy)tris(pentafluorophenyl)borate, (octyloxy)tris(pentafluorophenyl)borate, tetrakis[3,5-bis[1-methoxy-2,2,2-trifluoro-1-(trifluoromethyl)ethyl]pheny-1]borate, tetrakis[3-[1-methoxy-2,2,2-trifluoro-1-(trifluoromethyl)ethyl]-5-(trifluoromethyl)phenyl]borate, and tetrakis[3-[2,2,2-trifluoro-1-(2,2,2-trifluoroethoxy)-1-(trifluoromethyl)-ethyl]-5-(trifluoromethyl)phenyl]borate,
PF₆^{⊖}, SbF₆^{⊖}, n-C₄F₉SO₃^{⊖}, CF₃SO₃^{⊖}, p-CH₃(C₆H₄)—SO₃^{⊖}, (CF₃SO₂)CH and (CF₃SO₂)N^{⊖};
R₈, R₉, R₁₀, R₁₁ and R₁₂ are the same or different and each independently selected from the group consisting of halogen, methyl, ethyl, linear or branched (C₃-C₂₀)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl, (C₆-C₁₀)-aryloxy, (C₆-C₁₀)thioaryl, (C₁-C₆)alkanoyl(C₆-C₁₀)thioaryl, (C₁-C₆)alkoxy(C₆-C₁₀)aroyl(C₁-C₆)alkyl and (C₆-C₁₀)thioaryl-(C₆-C₁₀)diarylsulfonium salt;
c) one or more olefinic monomers of formula (IV): 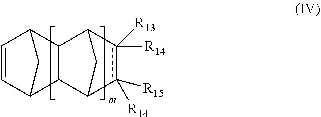
wherein:
m is an integer 0, 1 or 2; [symbol]
is a single bond or a double bond;
R₁₃, R₁₄, R₁₅ and R₁₆ are the same or different and each independently selected from the group consisting of hydrogen, halogen, a hydrocarbyl or halohydrocarbyl group selected from methyl, ethyl, linear or branched (C₃-C₁₆)alkyl, a fluorinated alkyl of formula C_{q}HₓF_{y}, where q is from 1 to 16, x is from 0 to 32, y is from 1 to 33 and sum of x+y=2q+1, epoxy, epoxy(C₁-C₁₂)alkyl, epoxy(C₁-C₁₂)alkoxy(C₁-C₁₂)alkyl, (C₃-C₁₂)cycloalkyl, epoxy(C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, (C₁-C₁₆)alkoxy(C₁-C₁₂)alkyl, perfluoro(C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy, (C₆-C₁₀)aryl(C₁-C₆)alkoxy, perfluoro(C₆-C₁₀)aryloxy,
perfluoro(C₆-C₁₀)aryl(C₁-C₃)alkoxy,
a group of formula (A):
—Z-Aryl (A);
a group of formula (A1): 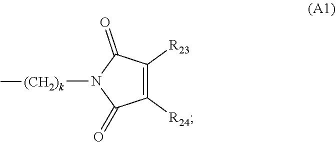
a group of formula (A2): 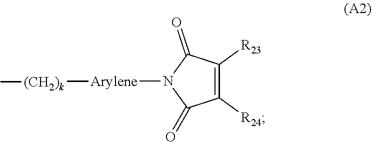
a group of formula (A3): 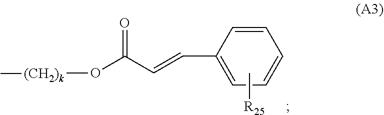
and
a group of formula (A4): 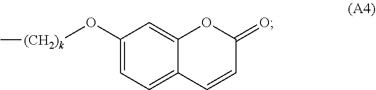
wherein:
Z is selected from the group consisting of:
O, CO, C(O)O, OC(O), OC(O)O, S, (CR₁₇R₁₈)_{d}, O(CR₁₇R₁₈)_{d}, (CR₁₇R₁₈)_{d}O, C(O)(CR₁₇R₁₈)_{d}, (CR₁₇R₁₈)_{d}C(O), C(O)O(CR₁₇R₁₈)_{d}, (CR₁₇R₁₈)_{d}C(O)O, OC(O)(CR₁₇R₁₈)_{d}, (CR₁₇R₁₈)_{d}OC(O), (CR₁₇R₁₈)_{d}OC(O)O, (CR₁₇R₁₈)_{d}OC(O)O(CR₁₇R₁₈)_{d}, OC(O)O(CR₁₇R₁₈)_{d}, S(CR₁₇R₁₈)_{d}, (CR₁₇R₁₈)_{d}S, (SiR₁₇R₁₈)_{d}, O(SiR₁₇R₁₈)_{d}, and (SiR₁₇R₁₈)_{d}O, where
R₁₇ and R₁₈ are the same or different and each independently selected from hydrogen, methyl, ethyl, linear or branched (C₃-C₁₂)alkyl, substituted or unsubstituted (C₆-C₁₄)aryl, methoxy, ethoxy, linear or branched (C₃-C₆)alkyloxy, (C₂-C₆)acyl, (C₂-C₆)acyloxy, and substituted or unsubstituted (C₆-C₁₄)aryloxy; and
d is an integer from 0 to 12, inclusive;
Aryl is selected from the group consisting of substituted or unsubstituted phenyl, substituted or unsubstituted biphenyl and substituted or unsubstituted naphthyl, substituted or unsubstituted terphenyl, substituted or unsubstituted anthracenyl substituted or unsubstituted fluorenyl, wherein the substituents are selected from the group consisting of halogen, methyl, ethyl, linear or branched (C₃-C₆)alkyl, perfluoro(C₁-C₁₂)alkyl, (C₃-C₁₂)cycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, methoxy, ethoxy, linear or branched (C₃-C₁₆)alkoxy, perfluoro(C₁-C₁₂)alkoxy, (C₃-C₁₂)cycloalkoxy, (C₆-C₁₀)aryloxy, (C₆-C₁₀)aryl(C₁-C₆)alkoxy, perfluoro(C₆-C₁₀)aryloxy and perfluoro(C₆-C₁₀)aryl(C₁-C₃)alkoxy;
k is an integer from 1 to 12, inclusive;
R₂₃, R₂₄ and R₂₅ are the same or different and each independently selected from the group consisting of hydrogen, methyl, ethyl, linear or branched (C₃-C₁₂)alkyl, a fluorinated alkyl of formula C_{q}HₓF_{y}, where q is from 1 to 16, x is from 0 to 32, y is from 1 to 33 and sum of x+y=2q+1, methoxy, ethoxy, linear or branched (C₃-C₁₂)alkoxy, (C₃-C₁₂)alkoxy(C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl and perfluoro(C₆-C₁₀)aryl(C₁-C₆)alkyl; or
R₂₃ and R₂₄ taken together with the intervening carbon atoms to which they are attached to form a substituted or unsubstituted (C₅-C₁₄)cyclic, (C₅-C₁₄)bicyclic or (C₅-C₁₄)tricyclic ring; and Arylene is substituted or unsubstituted bivalent (C₆-C₁₄)aryl;
or
one of R₁₃ and R₁₄ taken together with one of R₁₅ and R₁₆ and the carbon atoms to which they are attached to form a substituted or unsubstituted (C₅-C₁₄)cyclic, (C₅-C₁₄)bicyclic or (C₅-C₁₄)tricyclic ring;
and
d) a photosensitizer.

17. The kit according to claim 16, wherein the composition contains at least two distinct first and second monomers of formula (IV), wherein the first monomer and the photoacid generator are completely soluble in the second monomer, and when said composition is exposed to suitable actinic radiation for a sufficient length of time it forms a substantially transparent film having at least 90 percent of visible light transmission.

18. The kit according to claim 16, which contains a composition selected from the group consisting of:
5-phenethylbicyclo[2.2.1]hept-2-ene (PENB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(acetylacetonate)pyridine (Pd384), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-phenethylbicyclo[2.2.1]hept-2-ene (PENB), 3-(bicyclo[2.2.1]hept-5-en-2-yl)-7-oxabicyclo[4.1.0]heptane (CHEpNB), palladium bis(hexafluoroacetylacetonate)-tetrapyridine (Pd837), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,6-dimethylpyridine (Pd628), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-decylbicyclo[2.2.1]hept-2-ene (DecNB), palladium bis(hexafluoroacetylacetonate)-2,3,5,6-tetramethylpyrazine (Pd657), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX);
5-hexylbicyclo[2.2.1]hept-2-ene (HexylNB), palladium bis(hexafluoroacetylacetonate)-2,2′,6,6′-tetramethyl-4,4′-bipyridine (Pd733), di(4-n-dodecylphenyl)iodonium tetrakis(pentafluorophenyl)borate and 2-isopropyl-9H-thioxanthen-9-one (ITX); and
5-decylbicyclo[2.2.1]hept-2-ene (DecNB), palladium bis(hexafluoroacetylacetonate)-2,4,5-trimethyloxazole (Pd631), 4,4′-di-(C₁₀-C₁₃)alkylphenyl-iodonium tetrakis(2,3,4,5,6-pentafluorophenyl)borate (PAG1) and 2-isopropyl-9H-thioxanthen-9-one (ITX).

19. A film formed from the composition of claim 1.

20. The film formed from the composition of the kit according to claim 16.
